(19) United States
(12) Patent Application Publication
(10) Pub. No.: US 2023/0263161 A1
(43) Pub. Date: Aug. 24, 2023

(54) SYNERGISTIC DISINFECTANT COMPOSITIONS HAVING ENHANCED ANTIMICROBIAL EFFICACY AND STABILITY, AND METHODS OF USING THE SAME

(71) Applicant: Diversey, Inc., Fort Mill, SC (US)

(72) Inventors: Ying Zhou, Fort Mill, SC (US); Mariska Thayagan, Monroe, NC (US); Allegra Hug, Charlotte, NC (US); Xiabao Li, Durham, NC (US)

(21) Appl. No.: 18/140,160

(22) Filed: Apr. 27, 2023

Related U.S. Application Data
(63) Continuation-in-part of application No. 17/714,178, filed on Apr. 6, 2022.
Application No. 17/714,178 is a continuation of application No. 16/762,611, filed on May 8, 2020, now Pat. No. 11,330,819.
(60) Provisional application No. 62/786,176, filed on Dec. 28, 2018.
(60) Provisional application No. 62/923,650, filed on Oct. 21, 2019.

(51) Int. Cl. A01N 37/20; A01N 25/34; A01N 31/02; A01N 37/02; A01N 41/04; A01N 59/00

(52) U.S. Cl. CPC A01N 37/20; A01N 25/34; A01N 31/02; A01N 37/02; A01N 41/04; A01N 59/00

(57) ABSTRACT

A synergistic disinfectant composition comprises C1-8 organic acid in an amount of from about 0.1% to about 25.0% by weight; amino acid-based surfactant in an amount of from about 0.05% to about 20.0% by weight; an oxidizing agent in an amount of at least 0.1% but less than 5.0% by weight, all based on total weight of the disinfectant composition; and optionally the balance of water. When desired, the disinfectant composition further comprises anionic surfactant, stabilizing agent, or both. The amino acid-based surfactant comprises C10-24 fatty acid derivative of amino acid, wherein the amino acid is chosen from glycine, sarcosine, glutamic acid, aspartic acid, aminomalonic acid, or any combination thereof. Also disclosed is the method of disinfecting surface using the synergistic disinfectant composition.

### CROSS-REFERENCE TO RELATED APPLICATIONS

This application is a continuation-in-part patent application of U.S. patent application Ser. No. 17/714,178, filed on Apr. 6, 2022, which is a continuation patent application of U.S. patent application Ser. No. 16/762,611 (now U.S. patent Ser. No. 11/330,819 B2) that is a National Phase of PCT International Application No. PCT/US2019/066283, filed on Dec. 13, 2019 and claims priority to U.S. Provisional Application No. 62/786,176 filed on Dec. 28, 2018, and U.S. Provisional Application No. 62/923,650 filed Oct. 21, 2019; the content of these patent applications are incorporated by reference herein

### TECHNICAL FIELD

This disclosure relates to disinfectant compositions useful in institutional and healthcare applications.

### BACKGROUND

Conventional antimicrobial compositions typically used in liquid disinfectant often present limitations in reaching antimicrobial efficacies at the permitted levels. In addition, many of the compositions pose formulation stability challenges, especially when the concentrations of active ingredients are increased in order to achieve higher antimicrobial efficacy. This may result in unsatisfactory shelf life of the disinfectant compositions, as well as potential hazards under regular storage and use conditions. Some conventional liquid disinfectants purportedly contain both antimicrobial efficacy and biodegradability by using plant origin raw materials. These products, however, do not meet the expectations for desired product attributes (such as foaming profile) observed in commercial non-green, synthetic compositions. Further, biodegradable and plant origin raw materials often produce negative olfactory aspects (such as unpleasant odor) in conventional disinfectant products, causing unsatisfactory user experience and reducing the actual use of these products.

Therefore, there is a need for liquid disinfectant compositions that have one or more of enhanced antimicrobial efficacy, longer shelf life, improved stability, biodegradability, satisfactory foaming profile, improved olfactory aspects, and safer for consumer use.

### SUMMARY

In the first aspect, a synergistic disinfectant composition is provided that comprises C1-8 organic acid in an amount of from about 0.1% to about 25.0% by weight, amino acid-based surfactant in an amount of from about 0.05% to about 20.0% by weight based on total weight of the composition, and optionally the balance of water. Optionally, the disinfectant composition further comprises oxidizing agent in an amount of at least 0.1% but less than 5.0% by weight based on total weight of the composition. In certain embodiments, the oxidizing agent comprises hydrogen peroxide. Optionally, the disinfectant composition further comprises anionic surfactant in an amount of from about 0.1% to about 20.0% by weight based on total weight of the composition. Optionally, the disinfectant composition further comprises stabilizing agent in an amount of from about 0.05% to about 30.0% by weight of a based on total weight of the composition.

In second aspect, a synergistic disinfectant composition is provided that comprises C1-8 organic acid in an amount of from about 0.1% to about 25.0% by weight, amino acid-based surfactant in an amount of from about 0.05% to about 20.0% by weight, oxidizing agent in an amount of at least 0.1% but less than 5.0% by weight based on total weight of the composition, and optionally the balance of water. In certain embodiments, the oxidizing agent comprises hydrogen peroxide. Optionally, the disinfectant composition further comprises anionic surfactant in an amount of from about 0.1% to about 20.0% by weight based on total weight of the composition. Optionally, the disinfectant composition further comprises stabilizing agent in an amount of from about 0.05% to about 30.0% by weight based on total weight of the composition.

In the third aspect, a method of disinfecting a surface is provided. In some embodiments, the method comprises contacting the surface with the disclosed synergistic disinfectant composition. In some embodiments, the method comprises contacting the surface with disinfectant wipe, wherein the disinfectant wipe comprises textile medium embedded with the disclosed disinfectant composition.

Other aspects of the disclosure will become apparent by consideration of the detailed description.

### DETAILED DESCRIPTION

The present disclosure generally relates to a synergistic disinfectant composition, in which the antimicrobial efficacy is enhanced through the synergy between C1-8 organic acid and amino acid-based surfactant. When desired, the disclosed synergistic composition includes a stabilizing agent to achieve the stability with desired shelf life and to maintain the antimicrobial activity for at least one month after being stored at 40° C. In addition, the antimicrobial efficacy of the disclosed disinfectant composition may further be enhanced through the synergistic effect between the C1-8 organic acid and the stabilizing agent.

The singular forms “a”, “an”, and “the” include plural references unless the context clearly dictates otherwise.

The terms “comprise(s),” “comprising,” “include(s),” “including,” “having,” “has,” “contain(s),” “containing,” “characterized by,” and variants thereof are open-ended transitional phrases that are meant to encompass the items listed thereafter and equivalents thereof, as well as additional items. Where the term “comprising” is used, the present disclosure also contemplates other embodiments “comprising”, “consisting of”, or “consisting essentially of” elements presented herein, whether explicitly set forth or not.

The terms “consist(s) of”, “consisting of,” and variants thereof are close-ended transitional phrases, terms, or words that are meant to encompass the items listed thereafter and equivalents thereof, and to exclude additional items except for impurities ordinarily associated therewith.

The terms “consist(s) essentially of”, “consisting essentially of,” and variants thereof are meant to encompass the items listed thereafter and equivalents thereof, as well as additional items that do not materially affect the basic and novel characteristics.

Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

The term “about” used in connection with a quantity is inclusive of the stated value and has the meaning dictated by the context (for example, it includes at least the degree of error associated with the measurement of the particular quantity). The term “about” includes the rounding off value, so, for example “about 0.1” means from 0.055 to 0.144. The term “about” also includes plus or minus 10% of the indicated number. For examples, “about 10%” indicates a range from 9% to 11%, and “about 8” indicates a range from 7.2 to 8.8.

In general, the amount of a component in a composition as disclosed herein is expressed “by weight” which refers to the percentage of the component's weight in the total weight of the composition. Unless indicated otherwise, all concentrations are expressed as weight percentage concentrations.

The term “effective amount” refers to an amount effective that would achieve a desired effect or result. For example, an effective amount of a disinfectant composition may refer to the amount of such composition to achieve a level of antimicrobial activity, which can be measured with a standardized test known in the art. An effective amount of a disinfectant composition may be determined by known methods and may vary according to factors such as the microbial strains, test media, temperature, and other conditions.

The term “substantially the same antimicrobial activity” means that the antimicrobial activity is within at least 80%, preferably at least 90%, with respect to the reference antimicrobial activity.

The term “substantially free”, “free”, “substantially no”, or “no” refers to a disinfectant composition that does not contain a particular compound, or to which a particular compound has not been added to the disinfectant composition. Should the particular compound be present through contamination, the amount of such particular compound shall be less than 0.5% by weight, preferably less than 0.1% by weight.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March Marchs Advanced Organic Chemistry, 5th Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

The disclosed synergistic disinfectant composition comprises C1-8 organic acid in an amount of from about 0.1% to about 25.0% by weight, amino acid-based surfactant in an amount of from about 0.05% to about 20.0% by weight based on total weight of the composition, and optionally the balance of water. Optionally, the disinfectant composition further comprises oxidizing agent in an amount of at least 0.1% but less than 5.0% by weight based on total weight of the composition. In certain aspect, the oxidizing agent comprises hydrogen peroxide. Optionally, the disinfectant composition further comprises anionic surfactant in an amount of from about 0.1% to about 20.0% by weight based on total weight of the composition. Optionally, the disinfectant composition further comprises stabilizing agent in an amount of from about 0.05% to about 30.0% by weight based on total weight of the composition.

In some embodiments, the synergistic disinfectant composition comprises C1-8 organic acid in an amount of from about 0.1% to about 25.0% by weight, amino acid-based surfactant in an amount of from about 0.05% to about 20.0% by weight, oxidizing agent in an amount of at least 0.1% but less than 5.0% by weight based on total weight of the composition, and optionally the balance of water. In certain embodiments, the oxidizing agent comprises hydrogen peroxide. Optionally, the disinfectant composition further comprises anionic surfactant in an amount of from about 0.1% to about 20.0% by weight based on total weight of the composition. Optionally, the disinfectant composition further comprises stabilizing agent in an amount of from about 0.05% to about 30.0% by weight based on total weight of the composition.

C1-8 Organic Acid

The term “C1-8 organic acid” as used herein refers to a carboxylic acids that includes 1-8 carbon atoms and at least one carboxy (—COOH) group. The organic acid may have 0, 1, 2, or 3 carbon-carbon double bonds. The organic acid may have a straight or branched carbon chain, a cyclic carbon ring, and/or an aromatic carbon ring. The organic acid may be unsubstituted or substituted with one or more substituent groups, each of which independently selected from hydroxy (—OH), amino, cyano, halogen, thiol, oxo (═O), and thioxo (═S). In some embodiments, the “C1-8 organic acid” includes 1-8 carbon atoms, at least one carboxy (—COOH) group, and at least one hydroxy (—OH) group.

In some embodiments, the disclosed disinfectant composition comprises a single type of C1-8 organic acid. In some embodiments, the disclosed disinfectant composition comprises two or more types of C1-8 organic acids, such as a mixture of lactic acid and formic acid.

Non-limiting examples of suitable C1-8 organic acids include formic acid, acetic acid, propionic acid, butyric acid, isobutyric acid, valeric acid, isovaleric acid, caproic acid, heptanoic acid, caprylic acid, capric acid, lactic acid, glycolic acid, citric acid, malic acid, mandelic acid, tartaric acid, furoic acid, benzoic acid, salicylic acid, thiosalicylic acid, m-hydroxy benzoic acid, p-hydroxy benzoic acid, 3-hydroxy-4-methoxybenzoic acid, 2-aminobenzoic acid, 3,4,5-trichlorobenzoic acid, or any combination thereof.

In some embodiments, the disclosed disinfectant composition comprises C1-8 organic acid in an amount of from about 0.1% to about 50.0% by weight. In some embodiments, the disclosed disinfectant composition comprises at least 0.1%, at least 0.3%, at least 0.5%, at least 1.0%, at least 2.0%, at least 3.0%, at least 4.0%, at least 5.0%, at least 6.0%, at least 7.0%, at least 8.0%, at least 9.0%, at least 10.0%, at least 12.0%, at least 15.0%, at least 20.0%, at least 30.0%, or at least 40.0% by weight of C1-8 organic acid; and/or the disclosed disinfectant composition comprises less than 50.0%, less than 40.0%, less than 30.0%, less than 25.0%, less than 20.0%, less than 15.0%, less than 12.0%, less than 10.0%, less than 9.0%, less than 8.0%, less than 7.0%, less than 6.0%, less than 5.0%, less than 4.0%, less than 3.0%, less than 2.0%, or less than 1.0% by weight of C1-8 organic acid. In some embodiments, the disclosed disinfectant composition comprises about 0.1% to about 50.0%, about 0.1% to about 40.0%, about 0.1% to about 30.0%, about 0.1% to about 25.0%, about 0.1% to about 20.0%, about 0.1% to about 15.0%, about 0.1% to about 10.0%, or about 0.1% to about 5.0% by weight of C1-8 organic acid. In some embodiments, the disclosed disinfectant composition comprises about 0.5% to about 50.0%, about 0.5% to about 40.0%, about 0.5% to about 30.0%, about 0.5% to about 25.0%, about 0.5% to about 20.0%, about 0.5% to about 15.0%, about 0.5% to about 10.0%, about 0.5% to about 5.0% by weight of C1-8 organic acid. In some embodiments, the disclosed disinfectant composition comprises about 1.0% to about 50.0%, about 1.0% to about 40.0%, about 1.0% to about 30.0%, about 1.0% to about 25.0%, about 1.0% to about 20.0%, about 1.0% to about 15.0%, about 1.0% to about 12.0%, about 1.0% to about 10.0%, about 1.0% to about 8.0%, about 1.0% to about 6.0%, or about 1.0% to about 5.0% by weight of C1-8 organic acid. In some embodiments, the disclosed disinfectant composition comprises about 1.0% to about 25.0% by weight of C1-8 organic acid. In some embodiments, the disclosed disinfectant composition comprises about 0.5% to about 15.0% by weight, or about 1.0% to about 12.0% by weight of a C1-8 organic acid. In some embodiments, the disclosed disinfectant composition comprises about 0.1% to about 25.0% by weight of C1-8 organic acid.

Amino Acid-Based Surfactant

The term “amino acid-based surfactant” as used herein refers to a chemical compound derived from a natural or synthetic amino acid molecule and having surfactant properties. The amino acid based surfactant includes fatty acid derivative of amino acid, or salt thereof, in which fatty acid is attached to the amino acid through condensation of a carboxy group (—COOH) of the fatty acid and an amino group (—NH₂) of the amino acid to form an amide bond (—CONH—). Non-limiting examples of suitable amino acids include glycine, lysine, sarcosine, glutamic acid, aspartic acid, aminomalonic acid, or the like. Non-limiting examples of suitable fatty acids include a C10-24 fatty acid, such as C12-20 or C12-18 fatty acids.

The term “C10-24 fatty acid” as used herein refers to a carboxylic acid having 10-24 carbon atoms. The carboxylic acid may have from 0 to 8 carbon-carbon double bonds. The carboxylic acid may have a straight or branched carbon chain, a cyclic carbon ring, and/or an aromatic carbon ring. The carboxylic acid may be unsubstituted or substituted with one or more substituent groups, each of which independently selected from hydroxy (—OH), amino, cyano, halogen, thiol, oxo (═O), and thioxo (═S). Non-limiting examples of suitable C10-24 fatty acids includes lauric acid, myristic acid, palmitic acid, stearic acid, behenic acid, myristoleic acid, oleic acid, linoleic acid, eruic acid, docosahexanoic acid, or the like.

In some embodiments, the amino acid-based surfactant comprises a C10-24 fatty acid derivative of amino acid, wherein the amino acid is chosen from glycine, sarcosine, glutamic acid, aspartic acid, aminomalonic acid, or combinations thereof.

Non-limiting examples of suitable amino acid-based surfactants include sodium lauroyl sarcosinate, sodium cocoyl sarcosinate, sodium lauroyl glutamate, sodium cocoyl glutamate, sodium lauroyl glycinate, sodium cocoyl glycinate, sodium lauroyl aminomalonate, sodium cocoyl aminomalonate, sodium lauroyl aspartate, sodium cocoyl aspartate, or any combination thereof. Non-limiting examples of commercial amino acid-based surfactants include sarcosinates marketed under the tradenames Perlastan® (Schill+Seilacher GmbH), Maprosyl® (Stepan Company, USA), Crodasinic® (Croda, UK), Oramix® (Seppic, France), and acylglutamate products, marketed as Amisoft-® (Ajinomoto Corp., Japan).

In some embodiments, the disclosed disinfectant composition comprises at least 0.05%, at least 0.1%, at least 0.2%, at least 0.4%, at least 0.6%, at least 0.8%, at least 1.0%, at least 2.0%, at least 2.5%, at least 3.0%, at least 3.5%, at least 4.0%, at least 4.5%, at least 5.0%, at least 6.0%, at least 7.0%, at least 8.0%, at least 9.0%, at least 10.0%, at least 12.0%, at least 15.0%, at least 20.0%, or at least 25.0% by weight of amino acid-based surfactant; and/or the disclosed disinfectant composition comprises less than 30.0%, less than 25.0%, less than 20.0%, less than 15.0%, less than 12.0%, less than 10.0%, less than 9.0%, less than 8.0%, less than 7.0%, less than 6.0%, less than 5.0%, less than 4.5%, less than 4.0%, less than 3.5%, less than 3.0%, less than 2.5%, less than 2.0%, less than 1.5%, less than 1.0%, less than 0.8%, less than 0.6%, less than 0.4%, or less than 0.2% by weight of amino acid-based surfactant.

In some embodiments, the disclosed disinfectant composition comprises about 0.05% to about 30.0%, about 0.05% to about 25.0%, about 0.05% to about 20.0%, about 0.05% to about 15.0%, about 0.05% to about 10.0%, about 0.05% to about 8.0%, about 0.05% to about 6.0%, about 0.05% to about 5.0%, about 0.05% to about 4.0%, about 0.05% to about 3.0%, about 0.05% to about 2.0%, or about 0.05% to about 1.0% by weight of amino acid-based surfactant. In some embodiments, the disclosed disinfectant composition comprises about 0.1% to about 30.0%, about 0.1% to about 25.0%, about 0.1% to about 20.0%, about 0.1% to about 15.0%, about 0.1% to about 10.0%, about 0.1 to about 8.0%, about 0.1% to about 6.0%, about 0.1% to about 5.0%, about 0.1% to about 4.0%, about 0.1% to about 3.0%, about 0.1% to about 2.0%, or about 0.1% to about 1.0% by weight of amino acid-based surfactant. In some embodiments, the disclosed disinfectant composition comprises about 0.05% to about 20.0% by weight of an amino acid-based surfactant. In some embodiments, the disclosed disinfectant composition comprises about 0.1% to about 20.0% by weight of an amino acid-based surfactant. In some embodiments, the disclosed disinfectant composition comprises about 0.05% to about 10.0% by weight, or about 0.05% to about 5.0%, or about 0.05% to about 3.0% by weight of amino acid-based surfactant.

Oxidizing Agent

In some embodiments, the disclosed disinfectant composition comprises oxidizing agent. Non-limiting examples of suitable oxidizing agents include ammonium persulfate, sodium persulfate, potassium persulfate, hydrogen peroxide, tert-butyl hydroperoxide, cumene hydroperoxide, tert-amyl hydroperoxide, tert-butylperpivalate, tert-butyl perbenzoate, benzoyl peroxide, peroxyacids (like peracetic acid), ozone, chlorine dioxide, or any combination thereof. In some embodiments, the oxidizing agent comprises hydrogen peroxide.

In some embodiments, the disclosed disinfectant composition comprises at least 0.01%, at least 0.05%, at least 0.1%, at least 0.2%, at least 0.3%, at least 0.4%, at least 0.5%, at least 1.0%, at least 2.0%, at least 3.0%, or at least 4.0% by weight of oxidizing agent; and/or the disclosed disinfectant composition comprises less than 5.0%, less than 4.0%, less than 3.0%, less than 2.0%, less than 1.5%, less than 1.0%, less than 0.5%, less than 0.4%, less than 0.3%, less than 0.2%, or less than 0.1% by weight of oxidizing agent. In some embodiments, the disclosed disinfectant composition comprises 0.01% to about 5.0%, about 0.01% to about 4.0%, about 0.01% to about 3.0%, about 0.01% to about 2.0%, about 0.01% to about 1.5%, about 0.01% to about 1.0%, about 0.01% to about 0.5%, about 0.01% to about 0.4%, about 0.01% to about 0.3%, about 0.01% to about 0.2%, or about 0.01% to about 0.1% by weight of oxidizing agent. In some embodiments, the disclosed disinfectant composition comprises about 0.01% to about 1.5% by weight, or about 0.5% to about 1.5% by weight of oxidizing agent.

In some embodiments, the disclosed disinfectant composition comprises oxidizing agent and the oxidizing agent is peroxide, which is present in an amount of from about 0.5% to about 1.5% by weight based on total weight of the composition.

In some embodiments, the disclosed disinfectant composition comprises oxidizing agent and the oxidizing agent is peroxide, which is present in an amount of at least 0.1% but less than 5.0% by weight based on total weight of the composition.

In some embodiments, the disclosed disinfectant composition is substantially free of any oxidizing agent. As non-limiting examples, the disclosed disinfectant composition includes the oxidizing agent in an amount of less than 0.005%, less than 0.001%, less than 0.0005%, or less than 0.0001% by weight.

Stabilizing Agent

The term “stabilizing agent” as used herein refers to an agent that helps maintain the physical and chemical properties of the disinfectant compositions disclosed herein.

In some embodiments, the stabilizing agent comprises alcohol, polyol, glycol ether, or any combination thereof. The alcohol may be C1-6 alcohol. Non-limiting examples of alcohols include methanol, ethanol, propanol, isopropanol, 1-butanol, 1-pentanol, 2-pentanol, 1-hexanol, 2-hexanol, or any combination thereof. Non-limiting examples of the polyols (i.e., polyhydric alcohols) include ethylene glycol, propylene glycol, dipropylene glycol, glycerol, 1,2-butanediol, 1,3-butanediol, 1,4-butanediol, 2,3-butanediol, 1,2-propanediol, 1,5-pentanediol, meso-erythritol, neopentyl glycol, pentaerythritol, or any combination thereof. Examples of the glycol ethers include, but are not limited to, those based on ethylene or propylene glycol. Non-limiting examples of glycol ethers include diethylene glycol ethyl ether, dipropylene glycol methyl ether, diethylene glycol methyl ether, diethylene glycol propyl ether, diethylene glycol butyl ether, ethylene/diethylene glycol 2-ethylhexyl ether, ethylene glycol phenyl ether, dipropylene glycol propyl ether, dipropylene glycol butyl ether, propylene glycol phenyl ether, or any combination thereof.

In some embodiments of the present disclosure, the disinfectant composition is substantially free of aromatic alcohol, e.g., benzyl alcohol.

In some embodiments, the disclosed disinfectant composition comprises at least 0.05%, at least 0.1%, at least 0.2%, at least 0.5%, at least 1.0%, at least 2.0%, at least 3.0%, at least 4.0%, at least 5.0%, at least 6.0%, at least 7.0%, at least 8.0%, at least 9.0%, at least 10.0%, at least 12.0%, at least 15.0%, at least 20.0%, or at least 25.0% by weight of stabilizing agent; and/or the disclosed disinfectant composition comprises less than 30.0%, less than 25.0%, less than 20.0%, less than 15.0%, less than 12.0%, less than 10.0%, less than 9.0%, less than 8.0%, less than 7.0%, less than 6.0%, less than 5.0%, less than 4.0%, less than 3.0%, less than 2.0%, less than 1.0%, less than 0.5%, less than 0.2%, or less than 0.1% by weight of stabilizing agent.

In some embodiments, the disclosed disinfectant composition comprises about 0.05% to about 30.0%, about 0.05% to about 25.0%, about 0.05% to about 20.0%, about 0.05% to about 15.0%, about 0.05% to about 10.0%, about 0.05% to about 8.0%, about 0.05% to about 6.0%, about 0.05% to about 4.0%, about 0.05% to about 2.0%, or about 0.05% to about 1.0% by weight of stabilizing agent.

In some embodiments, the disclosed disinfectant composition comprises about 0.1% to about 30.0% by weight of stabilizing agent. In some embodiments, the disclosed disinfectant composition comprises about 0.1% to about 20.0% by weight of stabilizing agent. In some embodiments, the disclosed disinfectant composition comprises about 1.0% to about 10.0% by weight, or about 1.0% to about 6.0% by weight of stabilizing agent.

Anionic Surfactant

Suitable anionic surfactants for use in the compositions include, but are not limited to, alkyl sulfates, alkyl ether sulfates, alkyl aryl sulfonates, alpha-olefin sulfonates, alkali metal or ammonium salts of alkyl sulfates, alkali metal or ammonium salts of alkyl ether sulfates, alkyl phosphates, silicone phosphates, alkyl glyceryl sulfonates, alkyl sulfosuccinates, alkyl taurates, acyl taurates, sulfoacetates, alkyl phosphate esters, mono alkyl succinates, monoalkyl maleates, sulfoacetates, acyl isethionates, alkyl carboxylates, phosphate esters, sulfosuccinates (e.g., sodium dioctylsulfosuccinate), or any combination thereof. Non-limiting examples of anionic surfactants may include sodium lauryl sulfate, sodium lauryl ether sulfate, ammonium lauryl sulfosuccinate, ammonium lauryl sulfate, ammonium lauryl ether sulfate, sodium xylene sulfonate, sodium dodecylbenzene sulfonate, triethanolamine dodecylbenzene sulfonate, sodium cocoyl isethionate, sodium lauroyl isethionate, or any combination thereof.

In some embodiments, the anionic surfactant comprises alkyl sulfate, alkyl ether sulfate, alkyl aryl sulfonate, alpha-olefin sulfonates, or any combination thereof. Non-limiting examples of suitable alkyl sulfates include sodium or ammonium salts of C12-14 alcohol sulfate. Non-limiting examples of suitable alkyl ether sulfates include sodium or ammonium salts of C12-14 alcohol ethoxylate sulfate. Non-limiting examples of suitable alkyl aryl sulfonates include sodium xylene sulfonate, alkaline salt of C10-24 alkyl aryl sulfonate such as sodium dodecylbenzene sulfonate.

In some embodiments, the disclosed disinfectant composition is substantially free of linear benzyl benzene sulfonate, e.g., such as dodecylbenzenesulfonic acid.

In some embodiments, the disclosed disinfectant composition comprises at least 0.1%, at least 0.2%, at least 0.4%, at least 0.6%, at least 0.8%, at least 1.0%, at least 2.0%, at least 2.5%, at least 3.0%, at least 3.5%, at least 4.0%, at least 4.5%, at least 5.0%, at least 6.0%, at least 7.0%, at least 8.0%, at least 9.0%, at least 10.0%, at least 12.0%, at least 15.0%, at least 20.0%, or at least 25.0% by weight of anionic surfactant; and/or the disclosed disinfectant composition comprises less than 30.0%, less than 25.0%, less than 20.0%, less than 15.0%, less than 12.0%, less than 10.0%, less than 9.0%, less than 8.0%, less than 7.0%, less than 6.0%, less than 5.0%, less than 4.5%, less than 4.0%, less than 3.5%, less than 3.0%, less than 2.5%, less than 2.0%, less than 1.5%, less than 1.0%, less than 0.8%, less than 0.6%, less than 0.4%, or less than 0.2% by weight of anionic surfactant.

In some embodiments, the disclosed disinfectant composition comprises about 0.1% to about 30.0%, about 0.1% to about 25.0%, about 0.1% to about 20.0%, about 0.1% to about 15.0%, about 0.1% to about 10.0%, about 0.1 to about 8.0%, about 0.1% to about 6.0%, about 0.1% to about 5.0%, about 0.1% to about 4.0%, about 0.1% to about 3.0%, about 0.1% to about 2.0%, or about 0.1% to about 1.0% by weight of anionic surfactant. In some embodiments, the disclosed disinfectant composition comprises about 0.1% to about 20.0% by weight of anionic surfactant. In some embodiments, the disclosed disinfectant composition comprises about 0.2% to about 10.0% by weight, or about 0.2% to about 6.0% by weight of anionic surfactant.

In some embodiments, the disclosed disinfectant composition comprises at least 0.1%, at least 0.2%, at least 0.4%, at least 0.6%, at least 0.8%, at least 1.0%, at least 1.2%, at least 1.4%, at least 1.6%, at least 1.8%, at least 2.0%, at least 2.2%, at least 2.4%, at least 2.6%, at least 2.8%, at least 3.0%, at least 3.5%, at least 4.0%, at least 4.5%, at least 5.0%, at least 6.0%, at least 7.0%, at least 8.0%, at least 9.0%, at least 10.0%, at least 12.0%, or at least 14.0% by weight of alkyl sulfate anionic surfactant; and/or the disclosed disinfectant composition comprises less than 15.0%, less than 14.0%, less than 12.0%, less than 10.0%, less than 9.0%, less than 8.0%, less than 7.0%, less than 6.0%, less than 5.0%, less than 4.5%, less than 4.0%, less than 3.5%, less than 3.0%, less than 2.8%, less than 2.6%, less than 2.4%, less than 2.2%, less than 2.0%, less than 1.8%, less than 1.6%, less than 1.4%, less than 1.2%, less than 1.0%, less than 0.8%, less than 0.6%, less than 0.4%, or less than 0.2% by weight of alkyl sulfate anionic surfactant. In some embodiments, the disclosed disinfectant composition comprises about 0.1% to about 15.0%, about 0.1% to about 12.0%, about 0.1% to about 10.0%, about 0.1% to about 9.0%, about 0.1 to about 8.0%, about 0.1% to about 7.0%, about 0.1% to about 6.0%, about 0.1% to about 5.0%, about 0.1% to about 4.0%, about 0.1% to about 3.0%, about 0.1% to about 2.5%, about 0.1% to about 2.0%, about 0.1% to about 1.5%, or about 0.1% to about 1.0% by weight of alkyl sulfate anionic surfactant. In some embodiments, the disclosed disinfectant composition comprises about 0.2% to about 10.0% by weight or about 0.2% to about 3.0% by weight of alkyl sulfate anionic surfactant.

In some embodiments, the disclosed disinfectant composition comprises at least 0.1%, at least 0.2%, at least 0.4%, at least 0.6%, at least 0.8%, at least 1.0%, at least 1.2%, at least 1.4%, at least 1.6%, at least 1.8%, at least 2.0%, at least 2.2%, at least 2.4%, at least 2.6%, at least 2.8%, at least 3.0%, at least 3.5%, at least 4.0%, at least 4.5%, at least 5.0%, at least 6.0%, at least 7.0%, at least 8.0%, at least 9.0%, at least 10.0%, at least 12.0%, or at least 14.0% by weight of alkyl ether sulfate anionic surfactant; and/or the disclosed disinfectant composition comprises less than 15.0%, less than 14.0%, less than 12.0%, less than 10.0%, less than 9.0%, less than 8.0%, less than 7.0%, less than 6.0%, less than 5.0%, less than 4.5%, less than 4.0%, less than 3.5%, less than 3.0%, less than 2.8%, less than 2.6%, less than 2.4%, less than 2.2%, less than 2.0%, less than 1.8%, less than 1.6%, less than 1.4%, less than 1.2%, less than 1.0%, less than 0.8%, less than 0.6%, less than 0.4%, or less than 0.2% by weight of alkyl ether sulfate anionic surfactant. In some embodiments, the disclosed disinfectant composition comprises about 0.1% to about 15.0%, about 0.1% to about 12.0%, about 0.1% to about 10.0%, about 0.1% to about 9.0%, about 0.1 to about 8.0%, about 0.1% to about 7.0%, about 0.1% to about 6.0%, about 0.1% to about 5.0%, about 0.1% to about 4.0%, about 0.1% to about 3.0%, about 0.1% to about 2.5%, about 0.1% to about 2.0%, about 0.1% to about 1.5%, or about 0.1% to about 1.0% by weight of alkyl ether sulfate anionic surfactant. In some embodiments, the disclosed disinfectant composition comprises about 0.2% to about 10.0% by weight, or about 0.2% to about 3.0% by weight of alkyl ether sulfate anionic surfactant.

In some embodiments, the disclosed disinfectant composition comprises at least 0.1%, at least 0.2%, at least 0.4%, at least 0.6%, at least 0.8%, at least 1.0%, at least 1.2%, at least 1.4%, at least 1.6%, at least 1.8%, at least 2.0%, at least 2.2%, at least 2.4%, at least 2.6%, at least 2.8%, at least 3.0%, at least 3.5%, at least 4.0%, at least 4.5%, at least 5.0%, at least 6.0%, at least 7.0%, at least 8.0%, at least 9.0%, at least 10.0%, at least 12.0%, or at least 14.0% by weight of alkyl aryl sulfonate anionic surfactant; and/or the disclosed disinfectant composition comprises less than 15.0%, less than 14.0%, less than 12.0%, less than 10.0%, less than 9.0%, less than 8.0%, less than 7.0%, less than 6.0%, less than 5.0%, less than 4.5%, less than 4.0%, less than 3.5%, less than 3.0%, less than 2.8%, less than 2.6%, less than 2.4%, less than 2.2%, less than 2.0%, less than 1.8%, less than 1.6%, less than 1.4%, less than 1.2%, less than 1.0%, less than 0.8%, less than 0.6%, less than 0.4%, or less than 0.2% by weight of alkyl aryl sulfonate anionic surfactant. In some embodiments, the disclosed disinfectant composition comprises about 0.1% to about 15.0%, about 0.1% to about 12.0%, about 0.1% to about 10.0%, about 0.1% to about 9.0%, about 0.1 to about 8.0%, about 0.1% to about 7.0%, about 0.1% to about 6.0%, about 0.1% to about 5.0%, about 0.1% to about 4.0%, about 0.1% to about 3.0%, about 0.1% to about 2.5%, about 0.1% to about 2.0%, about 0.1% to about 1.5%, or about 0.1% to about 1.0% by weight of alkyl aryl sulfonate anionic surfactant. In some embodiments, the disclosed disinfectant composition comprises about 0.2% to about 10.0% by weight, or about 0.2% to about 3.0% by weight of alkyl aryl sulfonate anionic surfactant.

In some embodiments, the disclosed disinfectant composition comprises at least 0.1%, at least 0.2%, at least 0.4%, at least 0.6%, at least 0.8%, at least 1.0%, at least 1.2%, at least 1.4%, at least 1.6%, at least 1.8%, at least 2.0%, at least 2.2%, at least 2.4%, at least 2.6%, at least 2.8%, at least 3.0%, at least 3.5%, at least 4.0%, at least 4.5%, at least 5.0%, at least 6.0%, at least 7.0%, at least 8.0%, at least 9.0%, at least 10.0%, at least 12.0%, or at least 14.0% by weight of alpha-olefin sulfonate anionic surfactant; and/or the disclosed disinfectant composition comprises less than 15.0%, less than 14.0%, less than 12.0%, less than 10.0%, less than 9.0%, less than 8.0%, less than 7.0%, less than 6.0%, less than 5.0%, less than 4.5%, less than 4.0%, less than 3.5%, less than 3.0%, less than 2.8%, less than 2.6%, less than 2.4%, less than 2.2%, less than 2.0%, less than 1.8%, less than 1.6%, less than 1.4%, less than 1.2%, less than 1.0%, less than 0.8%, less than 0.6%, less than 0.4%, or less than 0.2% by weight of alpha-olefin sulfonate anionic surfactant. In some embodiments, the disclosed disinfectant composition comprises about 0.1% to about 15.0%, about 0.1% to about 12.0%, about 0.1% to about 10.0%, about 0.1% to about 9.0%, about 0.1 to about 8.0%, about 0.1% to about 7.0%, about 0.1% to about 6.0%, about 0.1% to about 5.0%, about 0.1% to about 4.0%, about 0.1% to about 3.0%, about 0.1% to about 2.5%, about 0.1% to about 2.0%, about 0.1% to about 1.5%, or about 0.1% to about 1.0% by weight of alpha-olefin sulfonate anionic surfactant. In some embodiments, the disclosed disinfectant composition comprises about 0.2% to about 10.0% by weight, or about 0.2% to about 3.0% by weight of alpha-olefin sulfonate anionic surfactant.

In some embodiments, the disclosed disinfectant composition comprises the anionic surfactant that fulfills at least one of the following: (a) the anionic surfactant is present in an amount of from about 0.1% to about 5.0% by weight based on total weight of the composition; (b) the anionic surfactant comprises alkyl sulfate, alkyl ether sulfate, alkyl aryl sulfonate, alpha-olefin sulfonate, or any combination thereof.

Other Optional Ingredients

In some embodiments, the disclosed disinfectant composition comprises at least one optional ingredient selected from pH adjusting agent, buffering agent, nonionic surfactant, hydrotrope, corrosion inhibitor, sequestering agent, antimicrobial compound, dye, rheology modifier, preservative, moisturizing agent, emollient, or any combination thereof. In some embodiments, each of the chosen optional ingredients is present in an amount of from about 0.01% to about 5.0%, from about 0.01% to about 4.0%, from about 0.01% to about 3.0%, from about 0.01% to about 2.0%, from about 0.01% to about 1.0%, from about 0.01% to about 0.5%, or from about 0.01% to about 0.1% by weight based on total weight of the composition.

Suitable pH adjusting agents include substances demonstrating an alkaline property or substances demonstrating an acidic property. Examples of substances demonstrating an alkaline property include, but are not limited to, alkali metal hydroxides such as sodium hydroxide and potassium hydroxide; carbonates such as sodium carbonate, sodium bicarbonate, and potassium carbonate; silicates such as sodium silicate and potassium silicate; borates such as sodium borate; organic acid salts such as sodium citrate; amines such as monoethanolamine and diethanolamine, and ammonia. Examples of substances that demonstrate an acidic property and used for pH adjustment include, but are not limited to, inorganic acids such as hydrochloric acid and sulfuric acid, or organic acids such as citric acid and acetic acid.

In some embodiments, the disclosed disinfectant composition has a pH of from about 0.01 to about 5. In some embodiments, the disclosed disinfectant composition has a pH of 5 or less. In some embodiments, the disclosed disinfectant composition has a pH value of less than 4.5, less than 4.0, less than 3.5, less than 3.0, less than 2.5, less than 2.0, less than 1.5, or even less than 1.0; and/or the disclosed disinfectant composition has a pH value of at least 0.1, at least 0.5, at least 1.0, at least 1.5, at least 2.0, at least 2.5, at least 3.0, at least 3.5, at least 4.0, or at least 4.5. In some embodiments, the pH is about 1.0 to about 3.0, including about 1.5 to about 3.0, about 2.0 to 3.0, about 2.1 to 3.0, about 2.2 to 3.0, about 2.2 to 3.0, about 2.3 to 3.0, about 2.4 to 3.0, or about 2.5 to 3.0. In some embodiments, the pH is about 2.0 to about 3.0, including about 2.1 to about 2.9, about 2.2 to 2.8, or about 2.3 to 2.8.

Suitable buffering agents may include, but are not limited to, phosphoric acid, monosodium phosphate, disodium phosphate, trisodium phosphate, citric acid and salts such as sodium citrate, benzoic acid, sodium benzoate, or any combination thereof.

Suitable nonionic surfactant may include, but are not limited to, ethylene oxide adducts of C8 to C22, preferably C8 to C16, more preferably C8 to C12 alcohols; ethylene oxide/propylene oxide adducts of ethylene glycol; alkylene glycols; alkyl polyglucosides; or mixtures thereof. Non-limiting examples of suitable types of non-ionic surfactant include ethoxylates of alkyl polyethylene glycol ethers, polyalkylene glycol (e.g., 100% Breox FCC92), or alcohol alkoxylate EO/PO (e.g., Plurafac LF403). Exemplary alcohol ethoxylates include fatty alcohol ethoxylates, e.g., tridecyl alcohol alkoxylate, ethylene oxide adduct, alkyl phenol ethoxylates, or ethoxy/propoxy block surfactants. In some embodiments, the nonionic surfactant is alcohol ethoxylates, EO/PO block copolymers, alkyl polyglucosides, or any combination thereof.

Suitable hydrotropes may include, but are not limited to, benzene sulfonates, naphthalene sulfonates, alkyl benzene sulfonates, naphthalene sulfonates, alkyl sulfonates, alkyl sulfates, alkyl diphenyloxide disulfonates, or phosphate ester hydrotropes. Exemplary alkyl benzene sulfonates include, for example, isopropylbenzene sulfonates, xylene sulfonates, toluene sulfonates, cumene sulfonates, or mixtures any two or more thereof. Exemplary alkyl sulfonates include hexyl sulfonates, octyl sulfonates, and hexyl/octyl sulfonates, or mixtures of any two or more thereof. In some embodiments, the hydrotrope comprises sodium xylene sulfonate, sodium cumene sulfonate, or combinations thereof.

Suitable corrosion inhibitors may include, but are not limited to, triazoles such as benzotriazole, tolyltriazole, and mercaptobenzothiazole; gluconate salts such as sodium gluconate, potassium gluconate and ammonium gluconate; molybdate salts such as sodium molybdate, or any combination thereof.

Suitable sequestering agents may include, but are not limited to, various known phosphate and non-phosphate builder materials. Non-limiting examples of suitable non-phosphate agents include alkali metal citrates; carbonates; bicarbonates; the salts of nitrilotriacetic acid (NTA), methylglycine diacetic acid (MGDA), or glutaric diacetic acid (GLDA); polycarboxylates such as polymaleates, polyacetates, polyhydroxyacrylates, polyacrylate/polymaleate and polyacrylate/polymethacrylate copolymers; zeolites, layered silica; or mixtures thereof. In some embodiments, the sequestering agent is selected from phosphates, NTA, EDTA, MGDA, GLDA, citrates, carbonates, bicarbonates, polyacrylate/polymaleate, or maleic anhydride/(meth)acrylic acid copolymers, e.g., Sokalan CP5 available from BASF.

The sequestering agent herein may also include anti-scalants, such as polyacrylates of molecular weight from 1,000 to 400,000, examples of which are supplied by Rohm & Haas, BASF and Alco Corp., or polymers based on acrylic acid combined with other moieties. These include acrylic acid combined with maleic acid, such as Sokalan CP5 and CP7 supplied by BASF or Acusol 479N supplied by Rohm & Haas with methacrylic acid such as Colloid 226/35 supplied by Rhone-Poulenc; with phosphonate such as Casi 773 supplied by Buckman Laboratories; with maleic acid and vinyl acetate such as polymers supplied by Huls; with acrylamide; with sulfophenol methallyl ether such as Aquatreat AR 540 supplied by Alco; with 2-acrylamido-2-methylpropane sulfonic acid such as Acumer 3100 supplied by Rohm & Haas or such as K-775 supplied by Goodrich; with 2-acrylamido-2-methylpropane sulfonic acid and sodium styrene sulfonate such as K-798 supplied by Goodrich; with methyl methacrylate, sodium methallyl sulfonate and sulfophenol methallyl ether such as Alcosperse 240 supplied by Alco; polymaleates such as Belclene 200 supplied by FMC; polymethacrylates such as Tamol 850 from Rohm & Haas polyaspartates; ethylenediamine disuccinate; or organo polyphosphonic acids and their salts such as the sodium salts of aminotri(methylenephosphonic acid) and ethane-1-hydroxy-1,1-diphosphonic acid. In some embodiments, the sequestering agent may be phosphate, phosphonates, EDTA, MGDA, GLDA, polyacrylates, or any combination thereof.

Suitable antimicrobial compounds may include agents that can kill or otherwise inhibit the growth or proliferation of microbes including, for example, bacteria, viruses or fungi. Examples of antimicrobial compounds include, but are not limited to, quaternary ammonium salts, essential oils, antimicrobial pesticides, antibacterials, antivirals, or antiparasitics known in the art.

The compositions may contain dyes used in disinfectant products to visualize coverage or pH sensitive dyes such as thymolphthalein, bromothyol blue, and phenol phenolphthalein.

Suitable rheology modifiers may include, but are not limited to, water soluble cellulosic polymers such as hydroxyethyl cellulose or hydroxypropyl cellulose.

Preservatives may include, but are not limited to, antimicrobials, biocides, or salts. For example, preservatives may include, but are not limited to, KATHON™ Preservatives (mixtures including methylchloroisothiazolinone and methylisothiazolinone from Dow Chemical, Midland, Mich.); NEOLONE 950™ (methylisothiazolinone from Dow Chemical, Midland, Mich.); DMDM hydantoin (available as GLYDANT™ from Lonza, Allendale, N.J.); iodopropynyl butylcarbamate; formaldehyde; benzoic esters (parabens), such as methylparaben, propylparaben, butylparaben, ethylparaben, isopropylparaben, isobutylparaben, benzylparaben; 2-bromo-2-nitropropane-1,3-diol; benzoic acid; formic acid; or those known to those skilled in the art.

In some embodiments, the disclosed disinfectant composition includes at least one skin conditioner such as an emollient, humectant, occlusive agent, or other moisturizing agent to provide moisturizing, skin softening, skin barrier maintenance, anti-irritation, or other skin health benefits. Some non-limiting examples of emollients include stearoxytrimethylsilane, alkyl benzoate, silicone oils, dimethicone, myristyl myristate, cetyl myristate, glyceryl dioleate, methyl laurate, PPG-9 laurate, octyl palmitate, lanolin, propylene glycol, glycerol, fatty acids, natural oils such as sunflower, almond, mineral, canola, sesame, soybean, wheat germ, corn, peanut and olive, isopropyl myristate, myristyl alcohol, aloe vera, hydrolyzed silk protein, Vitamin E, stearyl alcohol, isopropyl palmitate, sorbitol, amino acid complexes, or polyethylene glycol. Some non-limiting examples of humectants include hydroxyethyl urea, agarose, arginine PCA, fructose, glucose, glutamic acid, glycerol, honey, lactose, maltose, propylene glycol, polyethylene glycol, sorbitol, or any mixtures thereof. Some non-limiting examples of occlusive agents include petrolatum, shea butter, alkyl dimethicones, avocado oil, balm mint oil, canola oil, cod liver oil, corn oil, methicone, mineral oil, olive oil, phenyl trimethicone, trimyristin, soybean oil, glycol distearate, stearyl stearate, synthetic wax, or mixtures thereof. Some non-limiting examples of other moisturizers include cholesterol, cystine, hyaluronic acid, keratin, lecithin, egg yolk, glycine, PPG-12, panthenol, retinol, vegetable oil, or any mixtures thereof. Some non-limiting examples of anti-irritants include bisabolol or panthenol.

In some embodiments, the disclosed disinfectant composition has substantially the same antimicrobial activity after at least one month at 40° C. storage.

In some embodiments, the disclosed disinfectant composition comprises, all based on total weight of the composition:
C1-8 organic acid in an amount of from about 0.1% to about 25.0% by weight;
amino acid-based surfactant in an amount of from about 0.05% to about 20.0% by weight;
oxidizing agent in an amount of at least 0.1% but less than 5.0% by weight; and
optionally the balance of water.

In some embodiments, the disclosed disinfectant composition comprises, all based on total weight of the composition:
C1-8 organic acid in an amount of from about 0.1% to about 25.0% by weight;
amino acid-based surfactant in an amount of from about 0.05% to about 20.0% by weight;
oxidizing agent in an amount of at least 0.1% but less than 5.0% by weight, wherein the oxidizing agent comprises hydrogen peroxide; and
optionally the balance of water.

In some embodiments, the disclosed disinfectant composition comprises, all based on total weight of the composition:
C1-8 organic acid in an amount of from about 0.1% to about 25.0% by weight;
amino acid-based surfactant in an amount of from about 0.05% to about 20.0% by weight, wherein the amino acid-based surfactant comprises C10-24 fatty acid derivative of amino acid, wherein the amino acid is chosen from glycine, sarcosine, glutamic acid, aspartic acid, aminomalonic acid, or any combination thereof;
oxidizing agent in an amount of at least 0.1% but less than 5.0% by weight, wherein the oxidizing agent comprises hydrogen peroxide; and
optionally the balance of water.

In some embodiments, the disclosed disinfectant composition comprises, all based on total weight of the composition:
C1-8 organic acid in an amount of from about 0.1% to about 25.0% by weight;
amino acid-based surfactant in an amount of from about 0.05% to about 20.0% by weight, wherein the amino acid-based surfactant comprises sodium lauroyl sarcosinate, sodium cocoyl sarcosinate, sodium lauroyl glutamate, sodium cocoyl glutamate, sodium lauroyl glycinate, sodium cocoyl glycinate, sodium lauroyl aminomalonate, sodium cocoyl aminomalonate, sodium lauroyl aspartate, sodium cocoyl aspartate, or any combination thereof;
oxidizing agent in an amount of at least 0.1% but less than 5.0% by weight, wherein the oxidizing agent comprises hydrogen peroxide; and
optionally the balance of water.

In some embodiments, the disclosed disinfectant composition comprises, all based on total weight of the composition:
C1-8 organic acid in an amount of from about 0.1% to about 25.0% by weight;
amino acid-based surfactant in an amount of from about 0.05% to about 20.0% by weight, wherein the amino acid-based surfactant comprises sodium lauroyl sarcosinate, sodium cocoyl sarcosinate, sodium lauroyl glutamate, sodium cocoyl glutamate, sodium lauroyl glycinate, sodium cocoyl glycinate, sodium lauroyl aminomalonate, sodium cocoyl aminomalonate, sodium lauroyl aspartate, sodium cocoyl aspartate, or any combination thereof;
oxidizing agent in an amount of at least 0.1% but less than 5.0% by weight, wherein the oxidizing agent comprises hydrogen peroxide;
optionally anionic surfactant comprising alkyl sulfate, alkyl ether sulfate, alkyl aryl sulfonate, alpha-olefin sulfonate, or any combination thereof;
optionally stabilizing agent comprising alcohol, polyol, glycol ether, or any combination thereof; and
optionally the balance of water.

In some embodiments, the disclosed disinfectant composition comprises, all based on total weight of the composition:
C1-8 organic acid in an amount of from about 0.1% to about 25.0% by weight;
amino acid-based surfactant in an amount of from about 0.05% to about 20.0% by weight;
oxidizing agent in an amount of at least 0.1% but less than 5.0% by weight;
optionally anionic surfactant in an amount of from about 0.1% to about 30.0% by weight;
optionally stabilizing agent in an amount of from about 0.05% to about 30.0% by weight; and
optionally the balance of water

In some embodiments, the disclosed disinfectant composition comprises, all based on total weight of the composition:
C1-8 organic acid in an amount of from about 0.1% to about 25.0% by weight;
amino acid-based surfactant in an amount of from about 0.05% to about 20.0% by weight, wherein the amino acid-based surfactant comprises sodium lauroyl sarcosinate, sodium cocoyl sarcosinate, sodium lauroyl glutamate, sodium cocoyl glutamate, sodium lauroyl glycinate, sodium cocoyl glycinate, sodium lauroyl aminomalonate, sodium cocoyl aminomalonate, sodium lauroyl aspartate, sodium cocoyl aspartate, or any combination thereof;
oxidizing agent in an amount of at least 0.1% but less than 5.0% by weight, wherein the oxidizing agent comprises hydrogen peroxide;
optionally anionic surfactant in an amount of from about 0.1% to about 30.0% by weight, wherein the anionic surfactant comprises alkyl sulfate, alkyl ether sulfate, alkyl aryl sulfonate, alpha-olefin sulfonate, or any combination thereof;
optionally stabilizing agent in an amount of from about 0.05% to about 30.0% by weight, wherein the stabilizing agent comprises alcohol, polyol, glycol ether, or any combination thereof; and
optionally the balance of water.

In some embodiments, the disclosed disinfectant composition comprises, all based on total weight of the composition:
C1-8 organic acid in an amount of from about 0.1% to about 25.0% by weight;
amino acid-based surfactant in an amount of from about 0.05% to about 20.0% by weight, wherein the amino acid-based surfactant comprises sodium lauroyl sarcosinate, sodium cocoyl sarcosinate, sodium lauroyl glutamate, sodium cocoyl glutamate, sodium lauroyl glycinate, sodium cocoyl glycinate, sodium lauroyl aminomalonate, sodium cocoyl aminomalonate, sodium lauroyl aspartate, sodium cocoyl aspartate, or any combination thereof;
oxidizing agent in an amount of at least 0.1% but less than 5.0% by weight, wherein the oxidizing agent comprises hydrogen peroxide;
optionally anionic surfactant in an amount of from about 0.1% to about 30.0% by weight, wherein the anionic surfactant comprises alkyl sulfate, alkyl ether sulfate, alkyl aryl sulfonate, alpha-olefin sulfonate, alkali metal or ammonium salt of alkyl sulfate, alkali metal or ammonium salt of alkyl ether sulfate, alkyl phosphate, silicone phosphate, alkyl glyceryl sulfonate, alkyl sulfosuccinate, alkyl taurate, acyl taurate, sulfoacetate, alkyl phosphate ester, mono alkyl succinate, monoalkyl maleate, sulfoacetate, acyl isethionate, alkyl carboxylate, phosphate ester, sulfosuccinates, or any combination thereof;
optionally stabilizing agent comprising alcohol, polyol, glycol ether, or any combination thereof; and
optionally the balance of water.

In general, the disclosed disinfectant composition may be prepared by thoroughly mixing the ingredients at room temperature with a mixer or blender such that a homogeneous mixture is obtained. Commercially available ingredients are typically used without further purification or treatment. The ingredients may be dissolved in a solvent or liquid carrier (such as alcohol or water) to form a solution. Individual ingredients may be added during the preparation process in any order.

In some embodiments, the disclosed disinfectant composition is used without further dilution or further modification.

In some embodiments, the disclosed disinfectant composition is diluted with diluent, e.g., water, prior to use.

Also disclosed is a concentrate disinfectant composition that upon dilution with diluent (e.g., water) provides the disclosed disinfectant composition.

Additionally, disclosed is a two- or multi-component system that comprises at least two ingredients, wherein upon combining the at least two ingredients together provides the disclosed disinfectant composition.

Furthermore, disclosed in the present disclosure is a disinfectant wipe that comprises textile medium embedded with the disclosed disinfectant composition.

The disclosed disinfectant composition has antimicrobial activities measurable by assay methods known in the art, such as those described in “Guidance on the Biocidal Products Regulation, Volume II Efficacy—Assessment and Evaluation (Parts B+C)” (version 3.0, April 2018) and “Performance Criteria—Overview of (EN) Standards, Test Conditions, and Pass Criteria” (Appendix 4, BPR Efficacy Working Group Document, March 2017), both available at European Chemical Agency (ECHA), the entire contents of each of which are incorporated herein by reference.

In some embodiments, the disclosed disinfectant composition has an antimicrobial activity of log reduction of at least 2 under Biocidal Product Registration (BPR) standard EN 13727, EN 13624, or EN 1499. For example, the antimicrobial activity may achieve a log reduction of at least 2.0, at least 2.5, at least 3.0, at least 3.5, at least 4.0, at least 4.5, at least 5.0, at least 5.5, or at least 6.0 under BPR standard EN 13727, EN 1276, EN 13624, or EN 1499. This includes an antimicrobial activity of log reduction of about 2.5, about 3.0, about 3.5, about 4.5, about 5.0, about 5.5, or about 6.0. The antimicrobial activity may be in the range of log reduction of about 2.0 to about 6.0, about 2.0 to about 5.0, about 2.0 to about 4.0, about 2.0 to about 3.0, about 3.0 to about 6.0, about 3.0 to about 5.0, about 3.0 to about 4.0, about 4.0 to about 6.0, or about 4.0 to about 5.0. In particular embodiments, the compositions have an antimicrobial activity of log reduction of at least 2.0, at least 3.0, or at least 4.0 under the BPR standard tests. Other suitable measurement standards for antimicrobial activity include those described in the regulatory guidelines of United States Environmental Protection Agency (EPA), such as the EPA standard that applies the “Quantitative Methods for Evaluating the Activity of Microbicides used on Hard, Non-Porous Surface” issued by the Organisation for Economic Co-operation and Development (OECD) (hereinafter “the OECD Quantitative Methods for Evaluating the Activity of Microbicides”), or “Series 810—Product Performance Test Guidelines”, as well as those required by the health agencies in other countries. The disclosed compositions may satisfy the BPR standards, the EPA standard according to the OECD Quantitative Methods for Evaluating the Activity of Microbicides, and/or other standards intended to measure antimicrobial activity at a similar level using a similar testing procedure.

In some embodiments, the disclosed disinfectant composition has an antimicrobial activity of log reduction of at least 2, preferably at least 3, more preferably at least 4, under EPA standard applying the “Quantitative Methods for Evaluating the Activity of Microbicides used on Hard, Non-Porous Surface” issued by OECD; and/or the disclosed disinfectant composition has an antimicrobial activity of log reduction of at least 2, preferably at least 3, more preferably at least 4, under Biocidal Product Registration (BPR) standard EN 13727, EN 1276, EN 13624, or EN 1499.

Conventional organic acid-based antimicrobial actives that are used in liquid disinfectant often present limitations in reaching antimicrobial efficacies at the permitted levels. Advantageously, the present disclosure provides a disinfectant composition, in which the antimicrobial efficacy is enhanced through the synergy between C1-8 organic acids and amino acid-based surfactants. As a result, the disclosed disinfectant composition may achieve a desirable level of antimicrobial activity with a reduced amount of the antimicrobial actives, comparable to the currently available commercialized disinfectant products.

The disclosed disinfectant composition provides an enhanced antimicrobial efficacy, at least, through the unexpected synergistic effect between C1-8 organic acid and amino acid-based surfactant. See, e.g., EXAMPLES 1-18 and EXAMPLES 20-23. This unexpected synergistic antimicrobial efficacy between C1-8 organic acid and amino acid-based surfactant could be achieved against various microorganisms, such as bacteria, yeasts, fungi, spores, viruses, etc. As non-limiting examples, the disclosed disinfectant composition may provide a synergistic antimicrobial efficacy against the following microorganism: Staphylococcus aureus, Pseudomonas aeruginosa, Mycobacterium smegmatis, Candida albicans, Mycobacterium bovis, Trychophyton interdigitale, and the like. See, e.g., EXAMPLES 1, 3, 10-15 and 23 for S. aureus; EXAMPLES 2 and 4-9 for P. aeruginosa; EXAMPLES 16 and 17 for M. smegmatis; EXAMPLES 18, 20 and 21 for C. albicans; EXAMPLE 22 for T. interdigitale. Such an enhanced antimicrobial efficacy of the disclosed disinfectant composition may be achieved even without adding oxidizing agent (such as hydrogen peroxide) in the composition. See, e.g., EXAMPLES 14, 15, 17 and 21. Upon including oxidizing agent (e.g., hydrogen peroxide) into the disclosed disinfected composition, a further enhanced antimicrobial efficacy could be achieved. As a non-limiting example, EXAMPLE 21 shows that upon including hydrogen peroxide into the disinfectant composition (along with C1-18 organic acid and amino acid-based surfactant), the amount of C1-8 organic acid required to achieve the desirable antimicrobial efficacy could be reduced.

Generally when organic acid is used in combination with surface active ionic species (specifically amino acid-based surfactants), a rather high concentration of organic acid in the disinfectant composition is required in order to achieve the desired level of antimicrobial efficacy. This results in a poor physical stability of the disinfectant composition. The physical stability is further deteriorated when the disinfectant composition additionally includes oxidizing agent, such as peroxides and the like.

The disclosed disinfectant composition overcomes the aforementioned drawback of poor physical stability by including stabilizing agent in the disinfectant composition. The disclosed disinfectant composition achieves an improved physical stability with desired shelf life, and without interfering with the synergistic antimicrobial effect between amino acid-based surfactant and C1-8 organic acid. Furthermore, the disclosed disinfectant composition allows for an enhanced antimicrobial activity at a reduced concentration of active ingredient(s), with or without the use of oxidizing agent. As non-limiting examples, EXAMPLES 19 and 20 show that the physical stability of the disclosed disinfectant composition is significantly improved when stabilizing agent is included in the disinfectant composition. Moreover, the disclosed disinfectant composition may maintain the same antimicrobial activity even after at least one month at 40° C. storage. See EXAMPLE 20.

In some embodiments, the disclosed disinfectant composition has substantially the same antimicrobial activity after at least one month at 40° C. storage. In some embodiments, the disclosed disinfectant composition has substantially the same antimicrobial activity even after at least 3 months at 40° C. storage.

In some embodiments, the disclosed disinfectant composition is physically and chemically stable during storage. For example, the composition may be in the form of a liquid solution which maintains its physical appearance as a clear solution without detectable phase separation, precipitation, coloration, or crystallization of the solute during storage. The solution may maintain a constant pH or undergo minimum extent of degradation or chemical change in its ingredients including, for example, a degradation of less than 1.0%, less than 0.5%, less than 0.1%, less than 0.05%, or even 0.01% of its active ingredients. The duration of the storage, for example, may be about one month, about two months, about three months, about six months, about nine months, or even about twelve months.

In some embodiments, the disclosed disinfectant composition maintains substantially the same level of chemical and biological activities over the storage time. The property to “maintain” an antimicrobial activity as used herein means a product's ability to retain its antimicrobial activity at a level that is at least 90% of its original activity when the product is freshly prepared. For example, the disclosed disinfectant composition may maintain at least 90%, at least 91%, at least 92%, at least 93%, at least 94%, at least 95%, at least 96%, at least 97%, at least 98%, at least 99%, at least 99.5%, or even at least 99.9% of their antimicrobial activities over a time period of at least two weeks, at least one month, at least two months, at least three months, or even at least 6 months. The disclosed disinfectant composition may maintain about 90%, about 91%, about 92%, about 93%, about 94%, about 95%, about 96%, about 97%, about 98%, about 99%, about 99.5%, or even about 99.9% of the antimicrobial activity over a period of at least one month or at least three months. In some embodiments, the disinfectant composition maintains about 90%, about 91%, about 92%, about 93%, about 94%, about 95%, about 96%, about 97%, about 98%, about 99%, about 99.5%, or even about 99.9% of the antimicrobial activity over a period of at least three months.

In some embodiments, the disclosed disinfectant composition is stable over a temperature range of about 0° C. to about 50° C. including for example, about 0° C. to about 45° C., about 0° C. to about 40° C., about 0° C. to about 35° C., about 0° C. to about 30° C., about 0° C. to about 25° C. (or room temperature), or about 0° C. to about 20° C. storage. For example, the disinfectant composition may maintain their antimicrobial activities at a temperature of about 0° C., about 5° C., about 10° C., about 15° C., about 20° C., about 25° C., about 30° C., about 35° C., about 40° C., about 45° C., or even about 50° C. storage for a period of at least two weeks, at least one month, at least two months, at least three months, or even at least six months. In some embodiments, the disinfectant composition maintains about 90%, about 91%, about 92%, about 93%, about 94%, about 95%, about 96%, about 97%, about 98%, about 99%, about 99.5%, or even about 99.9% of the antimicrobial activity at a temperature range of about 0° C. to about 40° C. storage over a period of at least one month or at least three months. In some embodiments, the disinfectant composition maintains about 90%, about 91%, about 92%, about 93%, about 94%, about 95%, about 96%, about 97%, about 98%, about 99%, about 99.5%, or even about 99.9% of the antimicrobial activity at a temperature of about 0° C., about 25° C., or about 40° C. storage over a period of at least one month. In some embodiments, the disinfectant composition maintains about 90%, about 91%, about 92%, about 93%, about 94%, about 95%, about 96%, about 97%, about 98%, about 99%, about 99.5%, or even about 99.9% of the antimicrobial activity at a temperature of about 0° C., about 25° C., or about 40° C. storage over a period of at least three months.

In some embodiments, the stabilizing agent contributes to an increase in the antimicrobial efficacy of the disclosed disinfectant composition. At least, this may be due to the unexpected synergistic effect between the amino acid-based surfactant and the stabilizing agent. See EXAMPLE 23.

In some embodiments, the disclosed disinfectant composition is in the form of a solid (e.g., a powder or a tablet); or a liquid (e.g., a solution or a suspension). In some embodiments, the disinfectant composition is powder that is dissolved by a user with a suitable solvent (such as water) to prepare a liquid disinfectant. In some embodiments, the disinfectant composition is a ready-to-use solution. In some embodiments, the composition is a liquid concentrate, which is diluted by a user with a suitable diluent at a concentrate/diluent ratio of, for example, 1:1 to 1:1000 by weight. This includes a concentrate/diluent ratio of about 1:5, about 1:10, about 1:20, about 1:50, about 1:100, about 1:200, or about 1:500 by weight.

It has been known in the art that a disinfectant composition comprising salicylic acid in an amount of more than 0.2% weight, based on total weight of the composition, is rather difficult to achieve. This is due to the poor solubility of salicylic acid at such amount in water, thereby generally resulting on a phrase separation of the composition. Surprisingly, the disinfectant composition of present disclosure could be obtained at high level of salicylic acid (e.g., more than 0.2% weight based on total weight of the disinfectant composition), with high stability and excellent antimicrobial efficacy. See EXAMPLE 22.

The disinfectant composition disclosed herein may be built on plant-origin, biodegradable raw materials and demonstrate desired product attributes such as the foam profile comparable to commercial non-green product, at the same time providing enhanced antimicrobial efficacy. The disinfectant composition may have improved olfactory aspects compared to conventional disinfectant products that contain biodegradable and/or plant origin raw materials. For example, the compositions may be odorless or essentially free of any unpleasant odor. In some embodiments, the compositions disclosed herein may not produce any negative or unsatisfactory olfactory aspects and are therefore likely to be used more frequently, providing increased sanitization compliance (e.g., hand washing).

In another aspect, disclosed herein is a method of disinfecting a surface. In some embodiments, the disclosed method comprises contacting the surface with the disclosed synergistic disinfectant composition. In some embodiments, the disclosed method comprises contacting the surface with a disinfectant wipe, wherein the disinfectant wipe comprises textile medium embedded the disclosed disinfectant composition. Suitable surfaces that may be disinfected using the present compositions include, but are not limited to metal, ceramic, glass, plastic, stainless steel, or wood surfaces. Metal surfaces may include soft metal surfaces, such as aluminum or alloy surfaces. The surface may be a part of a ware, an instrument, a device, furniture, upholstery, or an operational platform used in household, restaurant, healthcare facilities, or other public areas. Examples of household surfaces including, but are not limited to, dishes, cooking wares, cooking devices or appliances, tables, stairs, floors, tiles, sinks, and toilets.

The disclosed disinfectant composition may also be used to disinfect a body surface of an animal, including human, cat, dog, or other animals. For example, the disinfectant composition may be used to disinfect the surface of a human's hand, leg, or other body parts. In some embodiments, the compositions may be used to disinfect human hands.

The following non-limiting examples illustrate the compositions of the present disclosure and methods of use thereof.

### EXAMPLES

Test Protocols for Antimicrobial Efficacy

Antimicrobial efficacy of the disinfectant composition was determined according to the regulatory guidelines of United States Environmental Protection Agency (EPA), according to the OECD Quantitative Methods for Evaluating the Activity of Microbicides. Furthermore, the antimicrobial efficacy was determined under the Biocidal Products Regulation (BPR) standard EN13727, EN13624, or EN1499 according to “Performance Criteria—Overview of (EN) Standards, Test Conditions, and Pass Criteria” (Appendix 4, BPR Efficacy Working Group Document, March 2017) available at European Chemical Agency (ECHA).

Reporting of Antimicrobial Efficacy

The antimicrobial efficacy was reported as an average log₁₀ reduction. The term “log₁₀ reduction” or “log reduction”, as used herein, is a mathematical term used to show the relative number of live microbial being reduced from a tested area. For example, “a log₁₀ reduction of 5” means lowering the number of microbial by 10⁵; “a log₁₀ reduction of 4” means lowering the number of microbial by 10⁴; “a log₁₀ reduction of 3” means lowering the number of microbial by 10³; “a log₁₀ reduction of 2” means lowering the number of microbial by 10²; and “a log₁₀ reduction of 1” means lowering the number of microbial by 10.

Determination for the Existence of Synergic Effect

An existence of synergic effect between antimicrobial ingredients in the tested disinfectant composition was determined using Colby's equation below to calculate the Expected Antimicrobial Efficiency (E):

$$E = X + Y - \frac{XY}{100}$$

wherein:
X is an antimicrobial efficiency (reported in an anti Log₁₀ value of the log₁₀ reduction) of the first antimicrobial ingredient at a given amount (p),
Y is an antimicrobial efficiency (reported in an anti Log₁₀ value of the log₁₀ reduction) of the second antimicrobial ingredient at a given amount (q), and
E is an expected antimicrobial efficiency (reported in an anti Log₁₀ value of the log₁₀ reduction) when combining the first antimicrobial ingredient at a given amount (p) and the second antimicrobial ingredient at a given amount (q).

The Observed Antimicrobial Efficiency (reported in an anti Log₁₀ value of the log₁₀ reduction) was measured for the tested disinfectant composition comprising the first antimicrobial ingredient at a given amount (p) and the second antimicrobial ingredient at a given amount (q).

Upon comparing the Observed Antimicrobial Efficiency to the Expected Antimicrobial Efficiency (E), an existence of synergic effect between the first and second antimicrobial ingredients in the tested antimicrobial composition can be determined:

If the Observed Antimicrobial Efficiency is greater than the Expected Antimicrobial Efficiency (E), there is a synergistic effect between the first and second antimicrobial ingredients in the tested disinfectant composition;

If the Observed Antimicrobial Efficiency is equaled to or less than the Expected Antimicrobial Efficiency (E), there is no synergistic effect between the first and second antimicrobial ingredients in the tested disinfectant composition.

### Example 1

TABLE 1 showed the micro efficacy of the tested disinfectant compositions against S. aureus based on the EPA standard according to the OECD Quantitative Methods for Evaluating the Activity of Microbicides. The C1-8 organic acid was a mixture of salicylic acid and lactic acid. The amino acid-based surfactant was sodium cocoyl glutamate, and the optional stabilizing agent was propylene glycol n-butyl ether (hereinafter “PnB”). The amounts of each ingredient in TABLE 1 were based on 100% active.

TABLE 1

| | #1 | #2 | #3 |
|---|---|---|---|
| Salicylic acid | — | 0.08 | 0.08 |
| Lactic acid | — | 0.38 | 0.38 |
| Hydrogen peroxide | 1.00 | 1.00 | 1.00 |
| Sodium cocoyl glutamate | 1.00 | — | 1.00 |
| PnB | 3.00 | 3 | 3.00 |
| Sodium xylene sulfonate | 0.30 | 0.30 | 0.30 |
| Water | ** | ** | ** |
| Micro Efficacy against S. aureus | | | |
| Observed Average Log₁₀ Reduction | 2.02 | 0.54 | 3.66 |
| Observed Average Reduction | 10^{2.02} = | 10^{0.54} = | 10^{3.66} = |
| (AntiLog₁₀ value) | 104.71 | 3.47 | 4,570.88 |
| Expected Reduction via Colby's Calculation | — | — | 104.55 |
| (AntiLog₁₀ value) | | | |

** The amount of water in the formulation was to complete 100% by weight

The “Expected Reduction via Colby's Calculation (Anti Log₁₀ value)” in the table was calculated using Colby's equation below:

$$E = X + Y - \frac{XY}{100}$$

wherein
X was an antimicrobial efficiency of C1-8 organic acid (a mixture of salicylic acid and lactic acid) and equaled to 104.71, which was an anti Log₁₀ value of the reported log₁₀ reduction of 2.02;
Y was an antimicrobial efficiency of sodium cocoyl glutamate and equaled to 3.47, which was an anti Log₁₀ value of the reported log₁₀ reduction of 0.54; and
E was an expected antimicrobial efficiency (reported in an anti Log₁₀ value) when C1-8 organic acid was used in combination with sodium cocoyl glutamate.

Thus, the Expected Antimicrobial Efficiency (E) was calculated to be 104.55, as shown below:

$$E = 104.71 + 3.47 - \frac{( 104.71 \times 3.47 )}{100} = 104.55$$

Disinfectant Composition #1, which contained C1-8 organic acids but not sodium cocoyl glutamate surfactant, provided a 2.02-log reduction against S. aureus. Disinfectant Composition #2, which contained sodium cocoyl glutamate surfactant but not C1-8 organic acids, provided a 0.54-log reduction. Disinfectant Composition #3, which contained both C1-8 organic acids and sodium cocoyl glutamate surfactant, provided a 3.66-log reduction against S. aureus that corresponded to the anti Log₁₀ value of 4,570.88.

If the effect between C1-8 organic acids and sodium cocoyl glutamate surfactant was merely an additive effect, the Expected Reduction via Colby's Calculation would be the anti Log₁₀ value of 104.55 as shown above.

The Observed Average Reduction was the anti Log₁₀ value of 4,570.88, which was more about 44 times higher than the Expected Reduction via Colby's Calculation (anti Log₁₀ value of 104.55). Therefore, Disinfectant Composition #3 showed a substantial synergistic antimicrobial effect between C1-8 organic acids and sodium cocoyl glutamate surfactant against S. aureus.

### Example 2

TABLE 2 showed the micro efficacy of the tested disinfectant compositions against P. aeruginosa based on the EPA standard according to the OECD Quantitative Methods for Evaluating the Activity of Microbicides. The C1-8 organic acid was furoic acid, and the amino acid-based surfactant was sodium cocoyl glycinate. Butyl carbitol was used as an optional stabilizing agent. The amounts of each ingredient in TABLE 2 were based on 100% active.

TABLE 2

| | #4 | #5 | #6 | #7 | #8 | #9 |
|---|---|---|---|---|---|---|
| Furoic acid | — | 0.3 | 0.3 | — | 0.3 | 0.3 |
| Hydrogen peroxide | — | 0.5 | 0.5 | 0.5 | — | 0.5 |
| Sodium cocoyl glycinate | 0.1 | — | 0.1 | 0.1 | — | 0.1 |
| Butyl carbitol | 5.0 | 5.0 | 5.0 | 5.0 | 5.0 | 5.0 |
| Water | ** | ** | ** | ** | ** | ** |
| Micro Efficacy against | | | | | | |
| P. aeruginosa | | | | | | |
| Observed Average | 0.23 | 2.26 | 5.91 | 2.79 | 2.08 | 5.91 |
| Log₁₀ Reduction | | | | | | |
| Observed Average | 10^{0.23} = | 10^{2.26} = | 10^{5.91} = | 10^{2.79} = | 10^{2.08} = | 10^{5.91} = |
| Reduction | 1.70 | 181.97 | 8 × 10⁵ | 616.60 | 120.23 | 8 × 10⁵ |
| (AntiLog₁₀ value) | | | | | | |
| Expected Reduction via | — | — | 180.58 | — | — | 736.82 |
| Colby's Calculation | | | | | | |
| (AntiLog₁₀ value) | | | | | | |

** The amount of water in the formulation was to complete 100% by weight

Disinfectant Composition #4 contained sodium cocoyl glycinate surfactant at 0.1% by weight based on total weight of the composition, butyl carbitol (optional stabilizing agent), and the balance of water. Disinfectant Composition #4 showed extremely poor antimicrobial activity against P. aeruginosa, with the observed log₁₀ reduction of only 0.23. This indicated that sodium cocoyl glycinate surfactant by itself provided poor and unacceptable antimicrobial efficacy.

Disinfectant Composition #5 contained furoic acid (C1-8 organic acid) and hydrogen peroxide as the active ingredients for antimicrobial purpose. Disinfectant Composition #5 provided the log₁₀ reduction of 2.26 against P. aeruginosa.

Disinfectant Composition #6 was essentially a combination of Disinfectant Compositions #4 and #5. Disinfectant Composition #6 provided an antimicrobial activity of 5.91 log₁₀ reduction against P. aeruginosa that corresponded to the anti Log₁₀ value of 8×10⁵.

The Observed Average Reduction was the anti Log₁₀ value of 8×10⁵, which was about 4,500 times higher than the Expected Reduction via Colby's Calculation (anti Log₁₀ value of 180.58). Therefore, Disinfectant Composition #6 showed a substantial synergistic antimicrobial effect between furoic acid and sodium cocoyl glycinate surfactant against P. aeruginosa.

Disinfectant Composition #7 contained sodium cocoyl glycinate surfactant at 0.1% by weight based on total weight of the composition, hydrogen peroxide, butyl carbitol, and the balance of water. Disinfectant Composition #7 provided an antimicrobial activity of 2.79 log₁₀ reduction against P. aeruginosa.

Disinfectant Composition #8, which contained fuoric acid as the active ingredient for antimicrobial purpose, provided the log₁₀ reduction of 2.08 against P. aeruginosa.

Disinfectant Composition #9 was essentially a combination of Disinfectant Compositions #7 and #8. Disinfectant Composition #9 provided an antimicrobial activity of 5.91 log₁₀ reduction against P. aeruginosa that corresponded to the anti Log₁₀ value of 8×10⁵. The Observed Average Reduction was the anti Log₁₀ value of 8×10⁵, which was about 1,100 times higher than the Expected Reduction via Colby's Calculation (anti Log₁₀ value of 736.82). Therefore, Disinfectant Composition #9 showed a substantial synergistic antimicrobial effect between furoic acid and sodium cocoyl glycinate surfactant against P. aeruginosa.

### Example 3

TABLE 3 showed the micro efficacy of the tested disinfectant compositions against P. aeruginosa based on the EPA standard according to the OECD Quantitative Methods for Evaluating the Activity of Microbicides. The C1-8 organic acid was furoic acid, and the amino acid-based surfactant was sodium lauroyl sarcosinate. Ethanol was used as an optional stabilizing agent. The amounts of each ingredient in TABLE 3 were based on 100% active.

TABLE 3

| | #10 | #11 | #12 | #13 | #14 | #15 |
|---|---|---|---|---|---|---|
| Furoic acid | — | 0.3 | 0.3 | — | 0.3 | 0.3 |
| Hydrogen peroxide | — | 0.5 | 0.5 | 0.5 | — | 0.5 |
| Sodium lauroyl sarcosinate | 0.1 | — | 0.1 | 0.1 | — | 0.1 |
| Ethanol | 5.0 | 5.0 | 5.0 | 5.0 | 5.0 | 5.0 |
| Water | ** | ** | ** | ** | ** | ** |
| Micro Efficacy against | | | | | | |
| S. aureus | | | | | | |
| Observed Average Log₁₀ | 0.00 | 2.32 | 4.78 | 3.11 | 1.17 | 4.78 |
| Reduction | | | | | | |
| Observed Average | 10^{0.00} = | 10^{2.32} = | 10^{4.78} = | 10^{3.11} = | 10^{1.17} = | 10^{4.78} = |
| Reduction | 1.00 | 208.93 | 6 × 10⁴ | 1288.24 | 14.80 | 6 × 10⁴ |
| (AntiLog₁₀ value) | | | | | | |
| Expected Reduction via | — | — | 207.84 | — | — | 192.85 |
| Colby's Calculation | | | | | | |
| (AntiLog₁₀ value) | | | | | | |

** The amount of water in the formulation was to complete 100% by weight

Disinfectant Composition #10 contained sodium lauroyl sarcosinate surfactant at 0.1% by weight based on total weight of the composition, ethanol (optional stabilizing agent), and the balance of water. Disinfectant Composition #10 showed substantially no antimicrobial activity against S. aureus.

Disinfectant Composition #11 contained furoic acid (C1-8 organic acid) and hydrogen peroxide as the active ingredients for antimicrobial purpose. Disinfectant Composition #11 provided the log₁₀ reduction of 2.32 against S. aureus.

Disinfectant Composition #12 was essentially a combination of Disinfectant Compositions #10 and #11. Disinfectant Composition #12 provided an antimicrobial activity of 4.78 log₁₀ reduction against S. aureus that corresponded to the anti Log₁₀ value of 6×10⁴. The Observed Average Reduction was the anti Log₁₀ value of 6×10⁴, which was about 290 times higher than the Expected Reduction via Colby's Calculation (anti Log₁₀ value of 207.84). Therefore, Disinfectant Composition #12 showed a substantial synergistic antimicrobial effect between furoic acid and sodium lauroyl sarcosinate surfactant against S. aureus.

Disinfectant Composition #13 contained sodium lauroyl sarcosinate surfactant at 0.1% by weight based on total weight of the composition, hydrogen peroxide, ethanol, and the balance of water. Disinfectant Composition #13 provided an antimicrobial activity of 3.11 log₁₀ reduction against S. aureus.

Disinfectant Composition #14, which contained fuoric acid as the active ingredient for antimicrobial purpose, provided the log₁₀ reduction of 1.17 against S. aureus.

Disinfectant Composition #15 was essentially a combination of Disinfectant Compositions #13 and #14. Disinfectant Composition #15 provided an antimicrobial activity of 4.78 log₁₀ reduction against S. aureus that corresponded to the anti Log₁₀ value of 6×10⁴. The Observed Average Reduction was the anti Log₁₀ value of 6×10⁴, which was about 312 times higher than the Expected Reduction via Colby's Calculation (anti Log₁₀ value of 192.85). Therefore, Disinfectant Composition #15 showed a substantial synergistic antimicrobial effect between furoic acid and sodium lauroyl sarcosinate surfactant against S. aureus.

### Example 4

TABLE 4 showed the micro efficacy of the tested disinfectant compositions against P. aeruginosa based on the EPA standard according to the OECD Quantitative Methods for Evaluating the Activity of Microbicides. The C1-8 organic acid was citric acid, and the amino acid-based surfactant was sodium lauroyl sarcosinate. Butyl carbitol was used as an optional stabilizing agent, and Polysorbate 80 was as used an optional nonionic surfactant. The amounts of each ingredient in TABLE 4 were based on 100% active.

TABLE 4

| | #16 | #17 | #18 |
|---|---|---|---|
| Citric acid | — | 0.10 | 0.10 |
| Sodium lauroyl sarcosinate | 0.10 | — | 0.10 |
| Hydrogen peroxide | — | 1.00 | 1.00 |
| Butyl carbitol | 5.00 | 5.00 | 5.00 |
| Polysorbate 80 | 0.01 | 0.01 | 0.01 |
| Water | ** | ** | ** |
| Micro Efficacy against P. aeruginosa | | | |
| (Log₁₀ Reduction) | | | |
| Observed Average Log₁₀ Reduction | 1.76 | 0.55 | 5.55 |
| Observed Average Reduction | 10^{1.76} = | 10^{0.55} = | 10^{5.55} = |
| (AntiLog₁₀ value) | 57.54 | 3.55 | 3 × 10⁵ |
| Expected Reduction via Colby's | — | — | 59.05 |
| Calculation | | | |
| (AntiLog₁₀ value) | | | |

** The amount of water in the formulation was to complete 100% by weight

Disinfectant Composition #16 contained sodium lauroyl sarcosinate surfactant at 0.1% by weight based on total weight of the composition, butyl carbitol (optional stabilizing agent), Polysorbate 80 (optional nonionic surfactant), and the balance of water. Disinfectant Composition #16 provided a log₁₀ reduction of 1.76 against P. aeruginosa.

Disinfectant Composition #17 contained citric acid (C1-8 organic acid) and hydrogen peroxide as the active ingredients for antimicrobial purpose. Disinfectant Composition #17 provided a log₁₀ reduction of 0.55 against P. aeruginosa.

Disinfectant Composition #18 was essentially a combination of Disinfectant Compositions #16 and #17. Disinfectant Composition #18 provided a log₁₀ reduction of 5.55 against P. aeruginosa that corresponded to the anti Log₁₀ value of 3×10⁵. The Observed Average Reduction was the anti Log₁₀ value of 3×10⁵, which was about 6,000 times higher than the Expected Reduction via Colby's Calculation (anti Log₁₀ value of 59.05). Therefore, Disinfectant Composition #18 showed a substantial synergistic antimicrobial effect between citric acid and sodium lauroyl sarcosinate surfactant against P. aeruginosa.

### Example 5

TABLE 5 showed the micro efficacy of the tested disinfectant compositions against P. aeruginosa based on the EPA standard according to the OECD Quantitative Methods for Evaluating the Activity of Microbicides. The C1-8 organic acid was mandelic acid, and the amino acid-based surfactant was sodium lauroyl sarcosinate. Butyl carbitol was used as an optional stabilizing agent, and Polysorbate 80 was used as an optional nonionic surfactant. The amounts of each ingredient in TABLE 5 were based on 100% active.

TABLE 5

| | #19 | #20 | #21 |
|---|---|---|---|
| Mandelic acid | — | 0.10 | 0.10 |
| Sodium lauroyl sarcosinate | 0.10 | — | 0.10 |
| Hydrogen peroxide | — | 1.00 | 1.00 |
| Butyl carbitol | 5.00 | 5.00 | 5.00 |
| Polysorbate 80 | 0.01 | 0.01 | 0.01 |
| Water | ** | ** | ** |
| Micro Efficacy against P. aeruginosa | 1.76 | 1.74 | 5.55 |
| (Log₁₀ Reduction) | | | |

** The amount of water in the formulation was to complete 100% by weight

Disinfectant Composition #19 contained sodium lauroyl sarcosinate surfactant at 0.1% by weight based on total weight of the composition, butyl carbitol (optional stabilizing agent), Polysorbate 80 (optional nonionic surfactant), and the balance of water. Disinfectant Composition #19 provided a log₁₀ reduction of 1.76 against P. aeruginosa.

Disinfectant Composition #20 contained mandelic acid (C1-8 organic acid) and hydrogen peroxide as the active ingredients for antimicrobial purpose. Disinfectant Composition #20 provided a log₁₀ reduction of 1.74 against P. aeruginosa.

Disinfectant Composition #21 was essentially a combination of Disinfectant Compositions #19 and #20. Disinfectant Composition #21 provided a log₁₀ reduction of 5.55 against P. aeruginosa, which was significantly higher than the expected additive antimicrobial activities of Disinfectant Compositions #19 and #20. Therefore, Disinfectant Composition #21 showed a substantial synergistic antimicrobial effect between mandelic acid and sodium lauroyl sarcosinate surfactant against P. aeruginosa.

### Example 6

TABLE 6 showed the micro efficacy of the tested disinfectant compositions against P. aeruginosa based on the EPA standard according to the OECD Quantitative Methods for Evaluating the Activity of Microbicides. The C1-8 organic acid was mandelic acid, and the amino acid-based surfactant was sodium lauroyl glutamate. Butyl carbitol was used as an optional stabilizing agent, and Polysorbate 80 was used as an optional nonionic surfactant. The amounts of each ingredient in TABLE 6 were based on 100% active.

TABLE 6

| | #22 | #23 | #24 |
|---|---|---|---|
| Mandelic acid | — | 0.10 | 0.10 |
| Sodium lauroyl glutamate | 0.10 | — | 0.10 |
| Hydrogen peroxide | — | 1.00 | 1.00 |
| Butyl carbitol | 5.00 | 5.00 | 5.00 |
| Polysorbate 80 | 0.01 | 0.01 | 0.01 |
| Water | ** | ** | ** |
| Micro Efficacy against P. aeruginosa | 1.36 | 1.74 | 5.53 |
| (Log₁₀ Reduction) | | | |

** The amount of water in the formulation was to complete 100% by weight

Disinfectant Composition #22 contained sodium lauroyl glutamate surfactant at 0.1% by weight based on total weight of the composition, butyl carbitol (optional stabilizing agent), Polysorbate 80 (optional nonionic surfactant), and the balance of water. Disinfectant Composition #22 provided a log₁₀ reduction of 1.36 against P. aeruginosa.

Disinfectant Composition #23 contained mandelic acid (C1-8 organic acid) and hydrogen peroxide as the active ingredients for antimicrobial purpose. Disinfectant Composition #20 provided a log₁₀ reduction of 1.74 against P. aeruginosa.

Disinfectant Composition #24 was essentially a combination of Disinfectant Compositions #22 and #23. Disinfectant Composition #24 provided a log₁₀ reduction of 5.53 against P. aeruginosa, which was significantly higher than the expected additive antimicrobial activities of Disinfectant Compositions #22 and #23. Therefore, Disinfectant Composition #24 showed a substantial synergistic antimicrobial effect between mandelic acid and sodium lauroyl glutamate surfactant against P. aeruginosa.

### Example 7

TABLE 7 showed the micro efficacy of the tested disinfectant compositions against P. aeruginosa based on the EPA standard according to the OECD Quantitative Methods for Evaluating the Activity of Microbicides. The C1-8 organic acid was citric acid, and the amino acid-based surfactant was sodium lauroyl glutamate. Butyl carbitol was used as an optional stabilizing agent, and Polysorbate 80 was as used an optional nonionic surfactant. The amounts of each ingredient in TABLE 7 were based on 100% active.

TABLE 7

| | #25 | #26 | #27 |
|---|---|---|---|
| Citric acid | — | 0.10 | 0.10 |
| Sodium lauroyl glutamate | 0.10 | — | 0.10 |
| Hydrogen peroxide | — | 1.00 | 1.00 |
| Butyl carbitol | 5.00 | 5.00 | 5.00 |
| Polysorbate 80 | 0.01 | 0.01 | 0.01 |
| Water | ** | ** | ** |
| Micro Efficacy against P. aeruginosa | 1.36 | 0.55 | 5.53 |
| (Log₁₀ Reduction) | | | |

** The amount of water in the formulation was to complete 100% by weight

Disinfectant Composition #25 contained sodium lauroyl glutamate surfactant at 0.1% by weight based on total weight of the composition, butyl carbitol (optional stabilizing agent), Polysorbate 80 (optional nonionic surfactant), and the balance of water. Disinfectant Composition #25 provided a log₁₀ reduction of 1.36 against P. aeruginosa.

Disinfectant Composition #26 contained citric acid (C1-8 organic acid) and hydrogen peroxide as the active ingredients for antimicrobial purpose. Disinfectant Composition #26 provided a log₁₀ reduction of 0.55 against P. aeruginosa.

Disinfectant Composition #27 was essentially a combination of Disinfectant Compositions #25 and #26. Disinfectant Composition #27 provided a log₁₀ reduction of 5.53 against P. aeruginosa, which was significantly higher than the expected additive antimicrobial activities of Disinfectant Compositions #25 and #26. Therefore, Disinfectant Composition #27 showed a substantial synergistic antimicrobial effect between citric acid and sodium lauroyl glutamate surfactant against P. aeruginosa.

### Example 8

TABLE 8 showed the micro efficacy of the tested disinfectant compositions against P. aeruginosa based on the EPA standard according to the OECD Quantitative Methods for Evaluating the Activity of Microbicides. The C1-8 organic acid was mandelic acid, and the amino acid-based surfactant was sodium cocoyl glycinate. Butyl carbitol was used as an optional stabilizing agent, and Polysorbate 80 was used as an optional nonionic surfactant. The amounts of each ingredient in TABLE 8 were based on 100% active.

TABLE 8

| | #28 | #29 | #30 |
|---|---|---|---|
| Mandelic acid | — | 0.10 | 0.10 |
| Sodium cocoyl glycinate | 0.10 | — | 0.10 |
| Hydrogen peroxide | — | 1.00 | 1.00 |
| Butyl carbitol | 5.00 | 5.00 | 5.00 |
| Polysorbate 80 | 0.01 | 0.01 | 0.01 |
| Water | ** | ** | ** |
| Micro Efficacy against P. aeruginosa | 2.86 | 1.74 | 5.53 |
| (Log₁₀ Reduction) | | | |

** The amount of water in the formulation was to complete 100% by weight

Disinfectant Composition #28 contained sodium cocoyl glycinate surfactant at 0.1% by weight based on total weight of the composition, butyl carbitol (optional stabilizing agent), Polysorbate 80 (optional nonionic surfactant), and the balance of water. Disinfectant Composition #22 provided a log₁₀ reduction of 2.86 against P. aeruginosa.

Disinfectant Composition #29 contained mandelic acid (C1-8 organic acid) and hydrogen peroxide as the active ingredients for antimicrobial purpose. Disinfectant Composition #20 provided a log₁₀ reduction of 1.74 against P. aeruginosa.

Disinfectant Composition #30 was essentially a combination of Disinfectant Compositions #28 and #29. Disinfectant Composition #30 provided a log₁₀ reduction of 5.53 against P. aeruginosa, which was significantly higher than the expected additive antimicrobial activities of Disinfectant Compositions #28 and #29. Therefore, Disinfectant Composition #30 showed a substantial synergistic antimicrobial effect between mandelic acid and sodium cocoyl glycinate surfactant against P. aeruginosa.

### Example 9

TABLE 9 showed the micro efficacy of the tested disinfectant compositions against P. aeruginosa based on the EPA standard according to the OECD Quantitative Methods for Evaluating the Activity of Microbicides. The C1-8 organic acid was citric acid, and the amino acid-based surfactant was sodium cocoyl glycinate. Butyl carbitol was used as an optional stabilizing agent, and Polysorbate 80 was used as an optional nonionic surfactant. The amounts of each ingredient in TABLE 9 were based on 100% active.

TABLE 9

| | #31 | #32 | #33 |
|---|---|---|---|
| Citric acid | — | 0.10 | 0.10 |
| Sodium cocoyl glycinate | 0.10 | — | 0.10 |
| Hydrogen peroxide | — | 1.00 | 1.00 |
| Butyl carbitol | 5.00 | 5.00 | 5.00 |
| Polysorbate 80 | 0.01 | 0.01 | 0.01 |
| Water | ** | ** | ** |
| Micro Efficacy | 2.86 | 0.55 | 5.53 |
| against P. aeruginosa | | | |
| (Log₁₀ Reduction) | | | |

** The amount of water in the formulation was to complete 100% by weight

Disinfectant Composition #31 provided a log₁₀ reduction of 2.86 against P. aeruginosa. Disinfectant Composition #32 provided a log₁₀ reduction of 0.55 against P. aeruginosa.

Disinfectant Composition #33 was essentially a combination of Disinfectant Compositions #31 and #32. Disinfectant Composition #33 provided a log₁₀ reduction of 5.53 against P. aeruginosa, which was significantly higher than the expected additive antimicrobial activities of Disinfectant Compositions #31 and #32. Therefore, Disinfectant Composition #33 showed a substantial synergistic antimicrobial effect between citric acid and sodium cocoyl glycinate surfactant against P. aeruginosa.

### Example 10

TABLE 10 showed the micro efficacy of the tested disinfectant compositions against S. aureus based on the EPA standard according to the OECD Quantitative Methods for Evaluating the Activity of Microbicides. The C1-8 organic acids was citric acid, and the amino acid-based surfactant was sodium lauroyl sarcosinate. Butyl carbitol was used as an optional stabilizing agent, and C9-22 alkyl ethoxylate was as used an optional nonionic surfactant. The amounts of each ingredient in TABLE 10 were based on 100% active.

TABLE 10

| | #34 | #35 | #36 |
|---|---|---|---|
| Citric acid | — | 0.10 | 0.10 |
| Sodium lauroyl sarcosinate | 0.05 | — | 0.05 |
| Hydrogen peroxide | — | 1.00 | 1.00 |
| Butyl carbitol | 5.00 | 5.00 | 5.00 |
| Alkyl ethoxylate | 0.01 | 0.01 | 0.01 |
| Water | ** | ** | ** |
| Micro Efficacy against S. aureus | 0.39 | 1.30 | 5.04 |
| (Log₁₀ Reduction) | | | |

** The amount of water in the formulation was to complete 100% by weight

Disinfectant Composition #34 contained sodium lauroyl sarcosinate surfactant at 0.05% by weight based on total weight of the composition, butyl carbitol (optional stabilizing agent), optional nonionic surfactant, and the balance of water. Disinfectant Composition #34 provided a log₁₀ reduction of 0.39 against S. aureus. Thus, sodium lauroyl sarcosinate surfactant provided negligible antimicrobial activity against S. aureus.

Disinfectant Composition #35 contained citric acid (C1-8 organic acid) and hydrogen peroxide as the active ingredients for antimicrobial purpose. Disinfectant Composition #35 provided a log₁₀ reduction of 1.30 against S. aureus.

Disinfectant Composition #36 was essentially a combination of Disinfectant Compositions #34 and #35. Disinfectant Composition #36 provided a log₁₀ reduction of 5.04 against S. aureus, which was significantly higher than the expected additive antimicrobial activities of Disinfectant Compositions #34 and #35. Therefore, Disinfectant Composition #36 showed a substantial synergistic antimicrobial effect between citric acid and sodium lauroyl sarcosinate surfactant against S. aureus.

### Example 11

TABLE 11 showed the micro efficacy of the tested disinfectant compositions against S. aureus based on the EPA standard according to the OECD Quantitative Methods for Evaluating the Activity of Microbicides. The C1-8 organic acid was a mixture of citric acid and lactic acid. The amino acid-based surfactant was sodium lauroyl sarcosinate. Butyl carbitol was used as an optional stabilizing agent, and alkyl benzylsulfonic acid was used as an optional anionic surfactant. The amounts of each ingredient in TABLE 11 were based on 100% active.

TABLE 11

| | #37 | #38 | #39 |
|---|---|---|---|
| Citric acid | 0.20 | — | 0.20 |
| Lactic acid | 0.10 | — | 0.10 |
| Sodium lauroyl sarcosinate | — | 0.05 | 0.05 |
| Hydrogen peroxide | 0.50 | — | 0.50 |
| Butyl carbitol | 5.00 | 5.00 | 5.00 |
| Alkyl benzylsulfonic acid | — | 0.20 | 0.20 |
| Water | ** | ** | ** |
| Micro Efficacy against S. aureus | 1.21 | 2.92 | 4.07 |
| (Log₁₀ Reduction) | | | |

** The amount of water in the formulation was to complete 100% by weight

Disinfectant Composition #37 provided a log₁₀ reduction of 1.21 against S. aureus. Disinfectant Composition #38, which contained sodium lauroyl sarcosinate surfactant at 0.05% by weight based on total weight of the composition, provided a log₁₀ reduction of 2.92 against S. aureus.

Disinfectant Composition #39 was essentially a combination of Disinfectant Compositions #37 and #38. Disinfectant Composition #39 provided a log₁₀ reduction of 4.07 against S. aureus, which was higher than the expected additive antimicrobial activities of Disinfectant Compositions #37 and #38. Therefore, Disinfectant Composition #39 showed a synergistic antimicrobial effect between sodium lauroyl sarcosinate surfactant and C1-8 organic acid (a mixture of citric acid and lactic acid) against S. aureus.

### Example 12

TABLE 12 showed the micro efficacy of the tested disinfectant compositions against S. aureus based on the EPA standard according to the OECD Quantitative Methods for Evaluating the Activity of Microbicides. The C1-8 organic acid was citric acid, and the amino acid-based surfactant was sodium lauroyl glutamate. Butyl carbitol was used as an optional stabilizing agent, and C9-22 alkyl ethoxylate was used as an optional nonionic surfactant. The amounts of each ingredient in TABLE 12 were based on 100% active.

TABLE 12

| | #40 | #41 | #42 |
|---|---|---|---|
| Citric acid | 0.10 | — | 0.10 |
| Sodium lauroyl glutamate | — | 0.05 | 0.05 |
| Hydrogen peroxide | 1.00 | — | 1.00 |
| Butyl carbitol | 5.00 | 5.00 | 5.00 |
| Nonionic surfactant | 0.01 | 0.01 | 0.01 |
| Water | ** | ** | ** |
| Micro Efficacy against S. aureus | 0.65 | 0.24 | 2.46 |
| (Log₁₀ Reduction) | | | |

** The amount of water in the formulation was to complete 100% by weight

Disinfectant Composition #40 provided a log₁₀ reduction of 0.65 against S. aureus. Disinfectant Composition #41, which contained sodium lauroyl glutamate surfactant at 0.05% by weight based on total weight of the composition, provided a log₁₀ reduction of 0.24 against S. aureus.

Disinfectant Composition #42 was essentially a combination of Disinfectant Compositions #40 and #41. Disinfectant Composition #42 provided a log₁₀ reduction of 2.46 against S. aureus, which was higher than the expected additive antimicrobial activities of Disinfectant Compositions #40 and #41. Therefore, Disinfectant Composition #42 showed a synergistic antimicrobial effect between citric acid and sodium lauroyl glutamate against S. aureus.

### Example 13

TABLE 13 showed the micro efficacy of the tested disinfectant compositions against S. aureus based on the EPA standard according to the OECD Quantitative Methods for Evaluating the Activity of Microbicides. The C1-8 organic acid was citric acid, and the amino acid-based surfactant was sodium cocoyl glycinate. Butyl carbitol was used as an optional stabilizing agent, and C9-22 alkyl ethoxylate was used as an optional nonionic surfactant. The amounts of each ingredient in TABLE 13 were based on 100% active.

TABLE 13

| | #43 | #44 | #45 |
|---|---|---|---|
| Citric acid | 0.10 | — | 0.10 |
| Sodium cocoyl glycinate | — | 0.05 | 0.05 |
| Hydrogen peroxide | 1.00 | — | 1.00 |
| Butyl carbitol | 5.00 | 5.00 | 5.00 |
| Nonionic surfactant | 0.01 | 0.01 | 0.01 |
| Water | ** | ** | ** |
| Micro Efficacy against S. aureus | 0.63 | 0.38 | 2.45 |
| (Log₁₀ Reduction) | | | |

** The amount of water in the formulation was to complete 100% by weight

Disinfectant Composition #43 provided a log₁₀ reduction of 0.63 against S. aureus. Disinfectant Composition #44, which contained sodium cocoyl glycinate surfactant at 0.05% by weight based on total weight of the composition, provided a log₁₀ reduction of 0.38 against S. aureus.

Disinfectant Composition #45 was essentially a combination of Disinfectant Compositions #43 and #44. Disinfectant Composition #45 provided a log₁₀ reduction of 2.45 against S. aureus, which was substantially higher than the expected additive antimicrobial activities of Disinfectant Compositions #43 and #44. Therefore, Disinfectant Composition #45 showed a synergistic antimicrobial effect between citric acid and sodium cocoyl glycinate surfactant against S. aureus.

### Example 14

TABLE 14 showed the synergistic effect between C1-8 organic acids (a mixture of salicylic acid and lactic acid) and sodium cocoyl glutamate surfactant against S. aureus under the EPA standard according to the OECD Quantitative Methods for Evaluating the Activity of Microbicides. The optional stabilizing agent was propylene glycol n-butyl ether (hereinafter “PnB”). The amounts of each ingredient in TABLE 14 were based on 100% active.

TABLE 14

| | #46 | #47 | #48 | #49 |
|---|---|---|---|---|
| Salicylic acid | 0.15 | — | 0.15 | 0.15 |
| Lactic acid | 0.75 | — | 0.75 | 0.75 |
| Hydrogen peroxide | 1.00 | 1.00 | 1.00 | — |
| Sodium cocoyl glutamate | — | 1.50 | 1.50 | 1.50 |
| PnB | 3.00 | 3.00 | 3.00 | 3.00 |
| Sodium xylene sulfonate | 0.30 | 0.30 | 0.30 | 0.30 |
| Water | ** | ** | ** | ** |
| Micro Efficacy against S. aureus | 5.03 | 2.95 | 6.38 | 6.38 |
| (Log Reduction) | | | | |

** The amount of water in the formulation was to complete 100% by weight

Disinfectant Composition #46, which contained C1-8 organic acids but not sodium cocoyl glutamate, provided a 5.03-log reduction against S. aureus. Disinfectant Composition #47, which contained sodium cocoyl glutamate but not C1-8 organic acids, provided a 2.95-log reduction against S. aureus. Disinfectant Composition #48 contained both C1-8 organic acids and sodium cocoyl glutamate. Disinfectant Composition #48 provided a 6.38-log reduction, which was higher than the additive antimicrobial efficacies of Disinfectant compositions #46 and #47. Therefore, there was a synergistic effect between C1-8 organic acids and sodium cocoyl glutamate surfactant against S. aureus.

Disinfectant Composition #49 contained the same ingredients as Disinfectant Composition #48, but without hydrogen peroxide (an oxidizing agent). The micro efficacy S. aureus of Disinfectant Composition #49 was about the same as Disinfectant Composition #48. Thus, such high efficacy against S. aureus was achieved even without the use of hydrogen peroxide in the disinfectant composition.

### Example 15

TABLE 15 showed the micro efficacy of the tested disinfectant compositions against S. aureus based on the EPA standard according to the OECD Quantitative Methods for Evaluating the Activity of Microbicides. The C1-8 organic acid was a mixture of salicylic acid and lactic acid. The amino acid-based surfactant was sodium lauroyl sarcosinate. The optional anionic surfactant was sodium xylene sulfonate; and the optional stabilizing agent was ethanol.

TABLE 15

| | #50 | #51 | #52 | #53 |
|---|---|---|---|---|
| Salicylic acid | — | 0.4 | 0.4 | 0.4 |
| Lactic acid | — | 2.2 | 2.2 | 2.2 |
| Hydrogen peroxide | 0.5 | 0.5 | 0.5 | — |
| Sodium lauroyl sarcosinate | 1.5 | — | 1.5 | 1.5 |
| Ethanol | 5.0 | 5.0 | 5.0 | 5.0 |
| Sodium xylene sulfonate | 0.3 | 0.3 | 0.3 | 0.3 |
| Water | ** | ** | ** | ** |
| Micro Efficacy against S. aureus | 3.29 | 0.82 | 6.38 | 6.38 |
| (Log Reduction) | | | | |

** The amount of water in the formulation was to complete 100% by weight

A very strong synergistic effect between C1-8 organic acids and amino acid-based surfactant against S. aureus was observed in the Disinfectant Composition #52. Disinfectant Composition #53 showed that the high efficacy against S. aureus were achieved even without the use of hydrogen peroxide in the competition.

### Example 16

M. smegmatis was known as the surrogate strain for M. tuberculosis. The micro efficacy of the disinfectant compositions was determined based on the EPA standard according to the OECD Quantitative Methods for Evaluating the Activity of Microbicides. TABLE 15 demonstrated the synergistic effect between C1-8 organic acid (a mixture of salicylic acid and lactic acid) and amino acid-based surfactant (sodium lauroyl sarcosinate) against M. smegmatis.

TABLE 16

| | #54 | #55 | #56 |
|---|---|---|---|
| Salicylic acid | 0.4 | 0.4 | 0.4 |
| Lactic acid | 2.2 | 2.2 | 2.2 |
| Hydrogen peroxide | 0.5 | 0.5 | 0.5 |
| Sodium sarcosinate | 0.45 | — | 0.45 |
| PnB | 0 | 3.8 | 3.8 |
| Sodium xylene sulfonate | 0.3 | 0.3 | 0.3 |
| Water | ** | ** | ** |
| Micro Efficacy against M. smegmatis | 0.57 | 4.51 | 6.07 |
| (Log Reduction) | | | |

** The amount of water in the formulation was to complete 100% by weight

### Example 17

TABLE 17 demonstrated the synergistic effect between organic acid and amino acid based surfactant against M. smegmatis under the EPA standard according to the OECD Quantitative Methods for Evaluating the Activity of Microbicides. The C1-8 organic acid was a mixture of salicylic acid, lactic acid, and formic acid. The amino acid-based surfactant was sodium lauroyl sarcosinate. The optional anionic surfactant was sodium xylene sulfonate; and the optional stabilizing agent was propylene glycol n-butyl ether (PnB).

Disinfectant Composition #59 showed that the high efficacy against M. smegmatis was achieved even without the use of hydrogen peroxide in the composition.

TABLE 17

| | #57 | #58 | #59 | #60 |
|---|---|---|---|---|
| Salicylic aicd | — | 0.3 | 0.3 | 0.3 |
| Lactic acid | — | 1.9 | 1.9 | 1.9 |
| Formic aicd | — | 1.0 | 1.0 | 1.0 |
| Hydrogen peroxide | 1.0 | 1.0 | 1.0 | — |
| Sodium lauroyl sarcosinate | 1.5 | 0 | 1.5 | 1.5 |
| PnB | 3.8 | 3.8 | 3.8 | 3.8 |
| Sodium xylene sulfonate | 0.3 | 0.3 | 0.3 | 0.3 |
| Water | ** | ** | ** | ** |
| Micro Efficacy against M. smegmatis | 0.38 | 4.13 | 6.13 | 6.13 |
| (Log Reduction) | | | | |

** The amount of water in the formulation was to complete 100% by weight

### Example 18

TABLE 18 demonstrated the synergistic effect between C1-8 organic acids and amino acid-based surfactant against Candida Albicans under the standard test EN13624. The C1-8 organic acid was a mixture of lactic acid and formic acid. The amino acid-based surfactant was sodium lauroyl sarcosinate. The optional stabilizing agent was ethanol. The optional anionic surfactants were sodium lauryl ether sulfate and sodium laureth sulfate.

TABLE 18

| | #61 | #62 | #63 | #64 | #65 |
|---|---|---|---|---|---|
| C1-8 Organic acid | 5.1 | — | 0.5 | 5.4 | 8.1 |
| Sodium lauryl sarcosinate | — | 9.0 | 9.0 | 9.0 | 9.0 |
| Ethanol | 5.2 | 5.2 | 5.2 | 5.2 | 5.2 |
| Glycerine | 1.0 | 1.0 | 1.0 | 1.0 | 1.0 |
| Sodium lauryl ether sulfate | 9.0 | 9.0 | 9.0 | 9.0 | 9.0 |
| Sodium laureth sulfate | 9.0 | 9.0 | 9.0 | 9.0 | 9.0 |
| Water | ** | ** | ** | ** | ** |
| Micro Efficiency against | <1 | <1 | 1.38 | 2.00 | 4.18 |
| Candida Albicans | | | | | |
| (Log reduction) | | | | | |

** The amount of water in the formulation was to complete 100% by weight

### Example 19

TABLE 19 showed an improved stability of the disinfectant composition upon including ethanol as an optional stabilizing agent in the composition. Disinfectant Composition #66, which did not include any ethanol stabilizing agent, was an unstable cloudy solution that resulted in a phase separation. Upon including the optional ethanol stabilizing agent in disinfectant composition (Disinfectant Compositions #67, #68 and #69), the stable clear solution was achieved.

TABLE 19

| | #66 | #67 | #68 | #69 |
|---|---|---|---|---|
| Lactic acid | 8.0 | 8.0 | 7.0 | 4.14 |
| Formic acid | 1.0 | 1.0 | — | 0.94 |
| Sodium lauryl sarcosinate | 3.5 | 3.5 | 4.0 | 2.70 |
| Sodium lauryl ether sulfate | 1.0 | 1.0 | 1.5 | 2.52 |
| Sodium laureth sulfate | 1.0 | 1.0 | 1.5 | 2.70 |
| Glycerine | 0.9 | 0.9 | 0.9 | 0.87 |
| Ethanol | — | 0.5 | 0.5 | 4.94 |
| Water | ** | ** | ** | ** |
| Appearance | Cloudy | Clear | Clear | Clear |
| | solution | solution | solution | solution |
| Stability | Phase | Stable | Stable | Stable |
| | separation | | | |

** The amount of water in the formulation was to complete 100% by weight

### Example 20

Disinfectant Composition #69 was tested for physical stability after being stored at a temperature of 40° C. for different storage time periods (0 day, 1 month, and 3 months). The micro efficacy of Disinfectant Composition #69 was determined against Candida Albicans under the standard test EN13624.

TABLE 20 showed that Disinfectant Composition #69 was physical stable and maintained its antimicrobial activity for at least three months during storage at 40° C.

TABLE 20

| Storage time | | | | Micro Efficacy Against |
|---|---|---|---|---|
| period | | Appearance | pH | Candida albicans |
| 0 | day | Clear, stable liquid | 2.70 | >4 |
| 1 | month | Clear, stable liquid | 2.70 | >4 |
| 3 | months | Clear, stable liquid | 2.78 | >4 |

### Example 21

Table 21 showed the micro efficacy of the tested disinfectant compositions against Candida albicans under the standard test EN 13624.

TABLE 21

| | #70 | #71 | #72 | #73 | #74 |
|---|---|---|---|---|---|
| C1-8 Organic acid | 9.5-10.5 | 9.5-10.5 | — | 10-11 | ~4 |
| Amino acid-based | — | — | 1.5-2.5 | 1.5-2.5 | 2.4 |
| surfactant | | | | | |
| Hydrogen peroxide | — | — | — | — | 0 0.5-1.5 |
| Alkyl ether | 0.95-1.05 | 2.5-3.0 | 2.5-3.0 | 0.95-1.05 | 2.0-2.5 |
| sulfate salt | | | | | |
| Alkyl sulfate salt | 0.9-1.0 | 2.5-3.0 | 2.5-3.0 | 1.5-2.0 | ~2.5 |
| Alpha-olefin | 1.1-1.2 | 0.9-1.0 | 0.9-1.0 | 0.9-1.0 | — |
| sulphonates | | | | | |
| Alcohols, | ~5 | 5 | ~5 | ~5 | ~5 |
| glycols, glycol | | | | | |
| ethers | | | | | |
| Water | ** | ** | ** | ** | ** |
| Micro Efficacy | <2 | <2 | <2 | >4 | >4 |
| against | | | | | |
| Candida albicans | | | | | |
| (Log Reduction) | | | | | |

** The amount of water in the formulation was to complete 100% by weight

Disinfectant Composition #70, which comprised C1-8 organic acid as the antimicrobial active but without amino acid-based surfactant, provided a log reduction of less than 2 against Candida albicans. As shown for Disinfectant Composition #71, no significant improvement in the antimicrobial activity was observed even when the amount of anionic surfactant was increased.

Disinfectant Composition #72, which comprised amino acid-based surfactant but without C1-8 organic acids, provided a log reduction of less than 2 against Candida albicans.

Disinfectant Composition #73, which comprised both C1-18 organic acid and amino acid-based surfactant, provided the log reduction of more than 4 against Candida albicans. These results demonstrated the synergistic antimicrobial efficacy between the amino acid-based surfactant and the C1-8 organic acid against Candida albicans.

Disinfectant Composition #74 demonstrated that upon including hydrogen peroxide (along with C1-18 organic acid and amino acid-based surfactant), the amount of C1-18 organic acid required to achieve the desired antimicrobial efficacy could be significantly reduced.

### Example 22

As demonstrated by Disinfectant Composition #78 in TABLE 22, the disinfectant composition comprised a high level of salicylic acid (e.g., more than 2% weight based on total weight of the composition) was achieved with high physical stability and excellent antimicrobial efficacy against T. interdigitale. The micro efficacy of the disinfectant compositions was determined based on the EPA standard according to the OECD Quantitative Methods for Evaluating the Activity of Microbicides.

TABLE 22

| | #75 | #76 | #77 | #78 |
|---|---|---|---|---|
| Salicylic acid | 0.80 | 0.80 | 1.60 | 2.40 |
| Sodium lauryl sarcosinate | — | 6.70 | 6.70 | 6.70 |
| Hydrogen peroxide | 4.25 | 4.25 | 4.25 | 4.25 |
| Phosphoric acid | 3.40 | 3.40 | 3.40 | 3.40 |
| Alkyl diphenyloxide | — | — | 3.80 | 3.80 |
| disulphonic acid Na salt | | | | |
| Alcohol ethoxylate | 5.00 | 5.00 | — | — |
| Ethanol | — | — | 20.00 | 20.00 |
| Water | ** | ** | ** | ** |
| Physical Stability | Clear | Phase | Clear | Clear |
| | | separation | | |
| Dilution | 1:16 | 1:16 | 1:16 | 1:16 |
| Fungicidal Efficacy | 4.32 | N/A | 5.60 | 5.60 |
| against T. interdigitale | | | | |
| (Log reduction) | | | | |

** The amount of water in the formulation was to complete 100% by weight

### Example 23

TABLE 23 demonstrated the synergistic effect between stabilizing agent and amino acid-based surfactant against S. aureus. The amino acid-based surfactant was sodium lauryl sarcosinate, and the stabilizing agent was PnB. The micro efficacy of the disinfectant composition was determined based on the EPA standard according to the OECD Quantitative Methods for Evaluating the Activity of Microbicides.

TABLE 23

| | #79 | #80 | #81 |
|---|---|---|---|
| Hydrogen peroxide | 0.5 | 0.5 | 0.5 |
| Sodium lauryl sarcosinate | 1.5 | — | 1.5 |
| PnB | — | 3.8 | 3.8 |
| Sodium xylene sulfonate | 0.3 | 0.3 | 0.3 |
| Water | ** | ** | ** |
| Micro Efficacy against | 0.23 | 0.16 | 0.68 |
| S. aureus | | | |
| (Log Reduction) | | | |

** The amount of water in the formulation was to complete 100% by weight

Various features and advantages of the invention are set forth in the following claims.

We claim:

1. A synergistic disinfectant composition, comprising:
C1-8 organic acid in an amount of from about 0.1% to about 25.0% by weight;
amino acid-based surfactant in an amount of from about 0.05% to about 20.0% by weight;
an oxidizing agent in an amount of at least 0.1% but less than 5.0% by weight, all based on total weight of the disinfectant composition; and
optionally the balance of water.

2. The composition of claim 1, wherein the oxidizing agent comprises hydrogen peroxide.

3. The composition of claim 1, wherein the composition comprises from about 0.1% to about 15.0% by weight of the C1-8 organic acid based on total weight of the composition.

4. The composition of claim 1, wherein the C1-8 organic acid comprises formic acid, acetic acid, propionic acid, butyric acid, isobutyric acid, valeric acid, isovaleric acid, caproic acid, heptanoic acid, caprylic acid, capric acid, lactic acid, glycolic acid, citric acid, malic acid, mandelic acid, tartaric acid, furoic acid, benzoic acid, salicylic acid, thiosalicylic acid, m-hydroxy benzoic acid, p-hydroxy benzoic acid, 3-hydroxy-4-methoxybenzoic acid, 2-aminobenzoic acid, 3,4,5-trichlorobenzoic acid, or any combination thereof.

5. The composition of claim 1, wherein the amino acid-based surfactant comprises C10-24 fatty acid derivative of amino acid, wherein the amino acid is chosen from glycine, sarcosine, glutamic acid, aspartic acid, aminomalonic acid, or any combination thereof.

6. The composition of claim 1, wherein the amino acid-based surfactant comprises sodium lauroyl sarcosinate, sodium cocoyl sarcosinate, sodium lauroyl glutamate, sodium cocoyl glutamate, sodium lauroyl glycinate, sodium cocoyl glycinate, sodium lauroyl aminomalonate, sodium cocoyl aminomalonate, sodium lauroyl aspartate, sodium cocoyl aspartate, or any combination thereof.

7. The composition of claim 1, wherein the composition comprises from about 0.05% to about 5.0% by weight of the amino acid based surfactant based on total weight of the composition.

8. The composition of claim 1, further comprising stabilizing agent chosen from alcohol, polyol, glycol ether, or any combination thereof.

9. The composition of claim 8, wherein the stabilizing agent is present in an amount of from about 0.05% to about 30.0% by weight based on total weight of the composition.

10. The composition of claim 1, further comprising anionic surfactant.

11. The composition of claim 10, wherein the anionic surfactant is present in an amount of from about 0.1% to about 20.0% by weight based on total weight of the composition.

12. The composition of claim 10, wherein the anionic surfactant comprises alkyl sulfate, alkyl ether sulfate, alkyl aryl sulfonate, alpha-olefin sulfonate, alkali metal or ammonium salt of alkyl sulfate, alkali metal or ammonium salt of alkyl ether sulfate, alkyl phosphate, silicone phosphate, alkyl glyceryl sulfonate, alkyl sulfosuccinate, alkyl taurate, acyl taurate, sulfoacetate, alkyl phosphate ester, mono alkyl succinate, monoalkyl maleate, sulfoacetate, acyl isethionate, alkyl carboxylate, phosphate ester, sulfosuccinates, or any combination thereof.

13. The composition of claim 10, wherein the anionic surfactant fulfills at least one of the following:
(a) the anionic surfactant is present in an amount of from about 0.1% to about 5.0% by weight based on total weight of the composition;
(b) the anionic surfactant comprises alkyl sulfate, alkyl ether sulfate, alkyl aryl sulfonate, alpha-olefin sulfonate, or any combination thereof.

14. The composition of claim 1, wherein the composition fulfills at least one of the following:
(a) the composition has a pH of from about 0.01 to about 5;
(b) the composition further comprises pH adjusting agent, buffering agent, nonionic surfactant, hydrotrope, corrosion inhibitor, sequestering agent, antimicrobial compound, dye, rheology modifier, preservative, moisturizing agent, emollient, or any combination thereof.

15. A concentrate disinfectant composition that, when diluted with water, produces the synergistic disinfectant composition of claim 1.

16. A diluted disinfectant composition obtained by diluting the synergistic disinfectant composition of claim 1 with water.

17. A two- or multi-component system comprising at least two ingredients, wherein upon combining the at least two ingredients together provide the synergistic disinfectant composition of claim 1.

18. A disinfectant wipe comprising textile medium embedded with the synergistic disinfectant composition of claim 1.

19. A method of disinfecting a surface, comprising contacting the surface with the synergistic disinfectant composition of claim 1.

20. A method of disinfecting a surface, comprising contacting the surface with the disinfectant wipe of claim 18.
